(19) United States
(12) Patent Application Publication
(10) Pub. No.: US 2019/0105779 A1
(43) Pub. Date: Apr. 11, 2019

(54) SYSTEMS AND METHODS FOR HUMAN AND ROBOT COLLABORATION

(71) Applicant: Polygon T.R. Ltd., Tzur-Yigal (IL)

(72) Inventor: Omer EINAV, Kfar-Monash (IL)

(73) Assignee: Polygon T.R Ltd., Tzur-Yigal (IL)

(21) Appl. No.: 16/086,637

(22) PCT Filed: Mar. 24, 2017
(86) PCT No.: PCT/IL2017/050367

§ 371 Date: Sep. 20, 2018

Related U.S. Application Data
(60) Provisional application No. 62/312,543, filed on Mar. 24, 2016.

(51) Int. Cl. B25J 9/16

(52) U.S. Cl. CPC B25J 9/1676; G05B 2219/40425; G05B 2219/40202; B25J 9/1697

(57) ABSTRACT

Robotic systems for simultaneous human-performed and robotic operations within a collaborative workspace are described. In some embodiments, the collaborative workspace is defined by a reconfigurable workbench, to which robotic members are optionally added and/or removed according to task need. Tasks themselves are optionally defined within a production system, potentially reducing computational complexity of predicting and/or interpreting human operator actions, while retaining flexibility in how the assembly process itself is carried out. In some embodiments, robotic systems comprise a motion tracking system for motions of individual body members of the human operator. Optionally, the robotic system plans and/or adjusts robotic motions based on motions which have been previously observed during past performances of a current operation.

### FIELD AND BACKGROUND OF THE INVENTION

The present invention, in some embodiment thereof, relates to collaborative, shared-workspace operations by humans and robots; and more particularly, but not exclusively, to assembly workstations where workers are assisted by robots to execute different tasks.

Assembly tasks are among the most frequent procedures where human workers cooperate with robots in order to execute a task. Today, most of these procedures rely on isolated work spaces for humans and robots, as a result of both safety concerns and lack of proper synchronization and operation methods that will allow smooth and safe work procedures.

### SUMMARY OF THE INVENTION

There is provided, in accordance with some embodiments of the present disclosure, a robotic system supporting simultaneous human-performed and robotic operations within a collaborative workspace, the robotic system comprising: at least one robot, configured to perform at least one robotic operation comprising movement within the collaborative workspace under the control of a controller; a station position, located to provide access to the collaborative workspace by human body members to perform at least one human-performed operation; and a motion tracking system, comprising at least one imaging device aimed toward the collaborative workspace to individually track positions of human body members within the collaborative workspace; wherein the controller is configured to direct motion of the at least one robot performing the at least one robotic operation, based on the individually tracked positions of body members performing the at least one human-performed operation.

In some embodiments, the motion is directed according to one or more safety considerations.

In some embodiments, the motion is directed according to one or more considerations of human-collaborative operation.

In some embodiments, the collaborative workspace is positioned over a working surface of the workbench accessible from the station, the station position is located along a side of the workbench, and the at least one robot is mounted to the workbench.

In some embodiments, the workbench comprises a rail mounted horizontally above the working surface, and the at least one robot is mounted to the rail.

In some embodiments, the individually tracked body members comprise two arms of a human operator.

In some embodiments, at least two portions of each tracked arm are individually tracked.

In some embodiments, the individually tracked body members comprise a head of the human operator.

In some embodiments, the motion tracking system tracks positions using markers worn on human body members.

In some embodiments, the robotic system includes the markers attached to human-wearable articles.

In some embodiments, the at least one imaging device comprises a plurality of imaging devices mounted to the workbench and directed to image the workspace over the working surface.

In some embodiments, the motion tracking system is configured to track human body member positions in three dimensions.

In some embodiments, the controller is configured to direct the motion of the at least one robot to avoid a position of at least one tracked human body member.

In some embodiments, the controller is configured to direct the motion of the at least one robot toward a region defined by a position of at least one tracked human body member.

In some embodiments, the controller is configured to direct the motion of the at least one robot performing the at least one robotic operation based on positions of human body members recorded during one or more prior performances of the at least one human-performed operation.

In some embodiments, the recorded positions are of a current human operator.

In some embodiments, the recorded positions are of a population of previous human operators.

In some embodiments, the controller is configured to direct the motion of the at least one robot performing the at least one robotic operation, based on predicted positions of the body members during the motion, wherein the predicted positions are predicted based on current movements of the body members.

In some embodiments, the predicted positions of the body members are predicted based on at least the current position and velocity of the body members.

In some embodiments, the predicted positions of the body members are further predicted based on the current acceleration of the body members.

In some embodiments, the controller is configured to predict future positions of body members based on matching of current positions of body members in the collaborative workspace to positions tracked during the prior performances.

In some embodiments, the controller predicts future positions based on positions recorded during the prior performances that followed the matching prior performance positions.

There is provided, in accordance with some embodiments of the present disclosure, a method of controlling a robot in a collaborative workspace, wherein the method comprises: recording positions of individual human body members performing a human-performed operation within the collaborative workspace; and then planning automatically motion of a robot moving within the collaborative workspace using the prior recordings of positions to define regions of the workspace to avoid or target; and moving automatically the robot within the collaborative workspace based on the planning, while the human-performed operation is performed.

In some embodiments, the robot is moved to avoid regions near positions of human body members in the prior recordings of positions.

In some embodiments, the avoiding is planned to reduce a risk of dangerous collision with human body members in the positions of human body members in the prior recordings of positions.

In some embodiments, the robot is moved to seek regions defined by positions of human body members in the prior recordings of positions.

In some embodiments, the regions defined are defined by an orientation and/or offset relative to the human body members in the prior recordings of positions.

In some embodiments, the seeking is planned to bring the robot into a region where it is directly available for collaboration with the human-performed operation.

In some embodiments, the method further comprises: recording, during the moving automatically, positions of human body members currently performing the human-performed operation; and adjusting the moving automatically, based on the positions of the human body members currently performing the human-performed operation.

In some embodiments, the adjusting is based on the current kinematic properties of the human body members currently performing the human-performed operation.

In some embodiments, the adjusting extrapolates future positions of the human body members currently performing the human-performed operation, using an equation of motion having parameters based on the current kinematic properties.

In some embodiments, the adjusting is based on a matching between current kinematic properties of the human body members, and kinematic properties of human body members previously recorded performing the human-performed operation.

There is provided, in accordance with some embodiments of the present disclosure, a robotic system supporting simultaneous human-performed and robotic operations within a collaborative workspace, the robotic system comprising: a workbench having a working surface for arrangement of items used in an assembly task, and defining the collaborative workspace thereabove; a robotic member; and a mounting rail, securely attached to the workbench, for operable mounting of the robotic member thereto within robotic reach of the collaborative workspace; wherein the robotic member is provided with a mounting and release mechanism allowing the robot to be mounted to and removed from the mounting rail without disturbing the arrangement of items on the working surface.

In some embodiments, the mounting and release mechanism comprises hand-operable control members.

In some embodiments, the robotic member is collapsible to a folded transportation configuration before release of the mounting mechanism.

There is provided, in accordance with some embodiments of the present disclosure, a robotic member comprising: a plurality of robotic segments joined by a joint; a robotic motion controller; wherein the joint comprises: two plates held separate from one another by a plurality of elastic members, and at least one distance sensor configured to sense a distance between the two plates; and wherein the robotic motion controller is configured to reduce motion of the robotic member, upon receiving an indication of a change in distance between the two plates from the distance sensor.

In some embodiments, the motion controller stops motion of the robotic member upon receiving the indication of the change in distance.

In some embodiments, the change in distance comprises tilting of one of the plates relative to the other, due to exertion of force on a load carried by the joint.

There is provided, in accordance with some embodiments of the present disclosure, a method of controlling a robotic system by a human operator, comprising: determining a current robotic task operation, based on a defined process flow comprising a plurality of ordered operations of the task; selecting, from a plurality of predefined operation-dependent indication contexts, an indication context defining indications relevant to the current robotic task operation; receiving an indication from a human operator; carrying out a robotic action for the current operation, based on a mapping between the indication and the indication context.

In some embodiments, the indication comprises a designation of an item or ref-lion indicated by a hand gesture of the human operator, and a spoken command from the human operator designating a robotic action using the designated item or region.

In some embodiments, the defined process flow comprises a sequence of operations, and the determining comprises selecting a next operation in the sequence of operations.

There is provided, in accordance with some embodiments of the present disclosure, a method of configuring a collaborative robotic assembly task, comprising: receiving a bill of materials and list of tools; receiving a list of assembly steps comprising actions using items from the list of tools and on the bill of materials; for each of a plurality of human operator types, receiving human operator data describing task-related characteristics of each human operator type; for each of the human operator types, assigning each assembly step to one or more corresponding operations, each operation defined by one or more actions from among a group consisting of at least one predefined robot-performed action and at least one human-performed action; and providing, for each of the plurality of human operator types, a task configuration defining a plurality of operations and commands in a programmed format suitable for use by a robotic system to perform the robot-performed actions, and human-readable instructions describing human-performed actions performed in collaboration with the robot-performed actions; wherein the task configuration is adapted for each human operator type, based on the human operator data.

In some embodiments, the method comprises validation of the provided task configurations by simulation.

In some embodiments, the method comprises providing, as part of each task configuration, a description of a physical layout of items from the bill of materials and the list of tools within a collaborative environment for performance of the assembly task.

In some embodiments, the method comprises designating human operator commands allowing switching among the plurality of operations.

In some embodiments, at least one of the plurality of human operator types is distinguished from at least one of the others by operator handedness, disability, size, and/or working speed.

In some embodiments, the plurality of human operator types is distinguished by differences in their previously recorded body member motion data while performing collaborative human-robot assembly operations.

There is provided, in accordance with some embodiments of the present disclosure, a method of optimizing a collaborative robotic assembly task, comprising: producing a plurality of different task configurations for accomplishing a single common assembly task result, each task configuration describing motion during sequences of collaborative human-robot operations performed in a task cell; monitoring motion of body members of a human operator and motion of a robot collaborating with the human operator while performing the assembly task according to each of the plurality of different task configurations; and selecting a task configuration for future assembly tasks, based on the monitoring.

In some embodiments, at least two of the plurality of different task configurations describe different placements of tools and/or parts in the task cell.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example, and for purposes of illustrative discussion of embodiments of the invention. In this regard, the description taken with the drawings makes apparent to those skilled in the art how embodiments of the invention may be practiced.

In the drawings:

FIG. 1A schematically illustrates a robotic task cell for collaborative work with a human operator, according to some embodiments of the present disclosure;

FIG. 1B schematically illustrates components of a robotic arm, according to some embodiments of the present disclosure.

FIG. 1C schematically represents a block diagram of a task cell, according to some embodiments of the present disclosure;

FIG. 2A schematically represents a task framework for human-robot collaboration, according to some embodiments of the present disclosure;

FIG. 2B is a schematic representation of different levels of safety and movement planning provided in a collaborative task cell, according to some embodiments of the present disclosure;

FIG. 3A schematically illustrates devices used in position monitoring of body members of a human operator of a robotic task cell, according to some embodiments of the present disclosure;

FIG. 3B schematically illustrates safety and/or targeting envelopes associated with position monitoring of body members of a human operator of a robotic task cell, according to some embodiments of the present disclosure;

FIGS. 3C-3E schematically illustrate markings and/or sensors worn by a human operator, and used in position monitoring of body members of a human operator of a robotic task cell, according to some embodiments of the present disclosure;

FIG. 4 is a flowchart schematically representing planning of robotic movements based on predictive assessment of the position(s) of human operator body members during the planned movement, according to some embodiments of the present disclosure;

FIGS. 5A-5C each schematically represent zones of anticipated position of body members of a human operator performing a task operation in collaboration with a robot, along with a predicted zone of collaboration, according to some embodiments of the present disclosure;

FIG. 6 is a schematic flowchart describing the generation and optional use for robotic activity control of a safety and/or targeting envelope predicted based on kinematic observations of the movement of a human operator, according to some embodiments of the present disclosure;

FIG. 7 schematically illustrates an example of a safety and/or targeting kinematic envelope generated and used according to the flowchart of FIG. 6, according to some embodiments of the present disclosure;

FIG. 8 schematically illustrates an example of generation and use of envelope, according to some embodiments of the present disclosure;

FIG. 9 illustrates the detection and use of hard operating limits, according to some embodiments of the present disclosure;

FIG. 10A schematically illustrates a robotic arm mounted on a rotational displacement force sensing device, and also comprising an axis displacement sensing device, according to some embodiments of the present disclosure;

FIGS. 10B-10C schematically illustrate construction features of an axis displacement force sensing device, according to some embodiments of the present disclosure;

FIGS. 10D-10E represent axis displacements of a robotic head incorporating the axis displacement force sensing device of FIGS. 10A-10C, according to some embodiments of the present disclosure;

FIGS. 10F-10G schematically illustrate normal and displaced positions of a portion of the rotational displacement force sensing device of FIG. 10A, according to some embodiments of the present disclosure;

FIG. 11 is a flowchart schematically illustrating a method of configuring and using a robotic task cell, according to some embodiments of the present disclosure;

FIG. 12 schematically illustrates a flowchart for designing a new collaborative task operation to be performed with a task cell, according to some embodiments of the present disclosure;

FIG. 13 is a flowchart schematically indicating phases of a typical defined robotic suboperation, according to some embodiments of the present disclosure;

FIG. 14 schematically illustrates a flowchart for the definition and optionally validation of a task (for example, an assembly and/or inspection task) for use with a task cell, according to some embodiments of the present disclosure;

FIGS. 15A-15B schematically illustrate views of a quick-connect mounting assembly for connecting a robotic arm to a mounting rail, according to some embodiments of the present disclosure;

FIGS. 16A-16B schematically illustrate, respectively, deployed and stowed (folded) positions of a robotic arm, according to some embodiments of the present disclosure;

FIG. 17A is a simplified sample bill of materials (BOM) for an assembly task, according to some embodiments of the present disclosure;

FIG. 17B shows a flowchart of an assembly task, according to some embodiments of the present disclosure;

FIG. 17C shows a task cell layout for an assembly task, according to some embodiments of the present disclosure;

FIG. 17D describes operations of two robot arms and a human during an assembly task, according to some embodiments of the present disclosure; and

FIG. 17E is a schematic flowchart that describes three different deburring strategies which could be adopted during an assembly task such as the assembly task of FIGS. 17A-17D, according to some embodiments of the present disclosure.

### DESCRIPTION OF SPECIFIC EMBODIMENTS OF THE INVENTION

The present invention, in some embodiment thereof, relates to collaborative, shared-workspace operations by humans and robots; and more particularly, but not exclusively, to assembly workstations where workers are assisted by robots to execute different tasks.

### Overview

A broad aspect of some embodiments of the present invention relates to configuring and controlling of robotic parts of human-robot collaborative task cells which are dynamically configurable to assist in tasks, such as assembly tasks, comprising a plurality of operations.

A collaborative task robotic task cell, in some embodiments, is operated by a human operator to perform multi-step tasks comprising a collection of more basic operations, each performed (optionally with robotic assistance) on one or more parts, assemblies of parts, or other items, optionally using one or more tools.

In some embodiments, operations of the task are ordered to be performed in a task flow comprising a predefined sequence. In some embodiments, a task process flow is defined which includes one or more operations which are performed optionally and/or in a variable order. In some embodiments, operations of the task may be performed in any suitable sequence—for example, the same operation is optionally repeated on several units (e.g., 5, 10, 100, 1000 or another smaller, larger or intermediate number), and/or a sequence of operations may be performed on one unit without interruption. Operations may be optional, e.g., due to product feature variations, the availability of alternative methods of achieving the same result, and/or due to an occasional need to modify or replace a part to achieve assembly.

Operations themselves are optionally predefined (e.g., as part of a library of such operations); optionally they are predefined with variable parameters, such as the locations of targets (objects and/or regions) of movement and/or manipulation. In some embodiments, parameters are defined by current inputs from a human operator; for example, targets for robotic actions are defined based on speech and/or gestures, or by another indication.

In some embodiments, operations are definable on the fly; for example, as a human operator devises a creative solution to optimize assembly, or to overcome an assembly problem.

A task may be performed several times by a human operator, for example, as part of the assembly of a batch of units. A task may be repeated, for example, 2, 4, 10, 20, 50, 100, 500 or another larger smaller or intermediate number of times. The task cell may then be used to perform another task by the same human operator; or the same task, performed by a different human operator. Optionally, the task cell is reconfigured physically and/or in software for different tasks and/or users.

Optionally, definitions of tasks and/or operations are refined over time, for example by deliberate adjustment and/or experimentation.

In some embodiments, available robotic actions comprise one or more of movement, tool operation, and material transport. In some embodiments, movement types include, for example, movements to reach and/or move between zones of other actions; avoidance movements to stay clear of obstructions, and in particular for safety avoidance of human body members; tracking movements to follow a moving target; guided movements, where movement is under close human supervision, for example actual physical guiding (grabbing the robot and tugging) or guidance by gestures or other indications; and/or approach movements, and in particular movements to safely approach a region where a collaborative action is to take place. In some embodiments, various types of stopping are encompassed under “movement” actions, including emergency (safety) stops, stops to await a next operation, autonomous stops to await a human operator's approach for a collaborative action; stops explicitly indicated by a human operator, for example by gesture and/or voice; and/or stops implicitly indicated by a human operator, for example by the human operator's approach to the robot for purposes of performing a collaborative action.

An aspect of some embodiments of the present invention relates to human-robot collaborative task cells comprising an integrated motion tracking system configured to track the movements of individual body members of a human operator within the task cell environment.

In some embodiments, a human-robot collaboration task cell is provided with one or more imaging devices configured, together with a suitable processor, to act as a motion tracking device for body members (e.g., arms and/or head) of a human operator (“motion tracking” should be understood to also include position sensing even in the absence of current motion). Tracking is optionally in two or three dimensions, with three dimensional motion tracking (e.g., based on analysis of images obtained from two or more vantage points) being preferred.

In some embodiments, image analysis to enable motion tracking is simplified by the use of operator-worn devices comprising optical markings. The optical markings are optionally provided on one or more human-wearable articles; for example, on stockings and/or gloves, rings, and/or headgear (hat, headband, and/or hairnet). Optionally, the markings are provided with properties of coloration, size, shape, and/or reflectance which allow them to be readily extracted by machine vision techniques from their background. Optionally, markings worn on different body parts are distinctive in their optical properties from one another as well, e.g., to assist in their automatic identification. Optionally, the markings are active (e.g., self-illuminating, for example using light emitting diodes). Optionally, light emitted from active markings is modulated differently for different markings, e.g., to assist in their automatic identification.

Optionally, individual locations of each tracked body member are distinguishable, for example, regions around joints (e.g., individual fingers and/or finger joints are distinguished; and/or hands, forearms, and/or upper arms are distinguished). Optionally, position tracking includes tracking of the orientations of body members. Optionally, body members are tracked as centroid positions, “stick” positions, and/or as at least approximate volumes of body members.

In some embodiments, motion tracking of body members is used in planning robotic movements and/or increasing the safety of the human operator. In some embodiments, the motion tracking is converted into defined safety and/or targeting envelopes (also referred to herein as safety and/or targeting “zones”), which define regions to be avoided and/or sought by robotic movements. The same envelope could be both avoided and sought simultaneously by different robotic parts moving simultaneously; for example, one robotic part tries to avoid a body member, while another one is brought into proximity to the body member in advance of a human-robot collaborative action. In some embodiments, zones are defined as regions within about 1 cm, 2 cm, 3 cm, 5 cm, 10 cm, or another larger, smaller or intermediate distance from a body member. Optionally, zones are defined as regions of some volume (for example, about 100 cm³, 500 cm³, 1000 cm³, 1500 cm³, or another larger, smaller, or intermediate volume) anchored at some distance and/or angle away from a body member, for example, near the distal end of a hand, within about 1 cm, 2 cm, 5 cm, 10 cm, or another larger, smaller or intermediate distance. Optionally, zones are defined as regions of contact with body members. Optionally different body members and/or parts thereof are protected by safety zones of different sizes; for example, the head is optionally protected by a larger zone than the hands. Optionally different parts of the same body member are protected with different-sized zones, for example, the eyes receive a larger protective zone than the crown of the head. Optionally, zones are defined as basic geometrical shapes or parts thereof, for example, cylinders, ellipsoids, spheres, cones, pyramids, and/or cubes. In some embodiments, zones are defined to generally follow contours of body members, for example as defined by worn indicators.

In some embodiments, motion tracking of body members is used in assessing (e.g., for purposes of improvement) aspects of task performance such as time efficiency, resource use, and/or quality of output. In some embodiments, motion tracking is used in the development and/or improvement of best practices for a task. Optionally, a human operator engages in deliberate adjustment and/or experimentation with how operations of a task are performed. Results of motion tracking are optionally used as part of the evaluation of the results. Additionally or alternatively, results of natural variations in task performance are evaluated. Evaluation is performed, for example, with respect to speed of an action, accuracy of an action, and/or changes to an action (lower demands on human operator motion, for example) expected to reduce a likelihood of stress, fatigue, and/or injury. Optionally, evaluation results are used to revise best practices used in training on and/or providing instructions for the task.

An aspect of some embodiments of the present invention relates to planning of robotic motion in a collaborative workspace, based on previously measured physical positions of one or more body members of a human operator within the collaborative workspace.

In some embodiments, motion tracking capability of a collaborative task cell is used to record and store movements of human operators during the performance of task operations using the task cell. During subsequent performance of the operations, in some embodiments, previously observed motions and/or positions of body members of the human operators (optionally, of the current human operator in particular) are used by the robotic controller to help plan robotic movements.

In some embodiments, the planning is toward the goal of avoiding unsafe robotic movements in the predicted vicinity of the human operator's body members, while maintaining robotic efficiency (e.g., not slowing and/or redirecting robotic movements to the extent that overall task time is significantly lengthened).

In some embodiments, at least some of the planning occurs in advance of the anticipated movements it avoids; that is, before it is possible to anticipate movements based on current, ongoing kinematics. A potential advantage of this is to avoid at least some possible interruptions in planned motions that might otherwise reduce efficiency.

In some embodiments, motion-tracked ongoing movements of the human operator are used to infer where collisions are potentially about to occur. Optionally, the system revises a planned and/or ongoing motion to reduce the likelihood of unsafe human-robot collision: to prevent impact at all, and/or to prevent impact while the robot is moving at high relative velocity. Optionally, equations of motion are used to infer where collisions may be imminent. Optionally, past recordings of motion tracked behavior are matched to a current motion profile (for example, current position, velocity and/or acceleration) in order to infer most likely near-future positions of human operator body members. In some embodiments, unsafe robotic contact comprises one or more of, for example: (1) contact with a robotic part above a certain net velocity, (2) contact with a robotic part where the robotic component of the velocity is above a certain velocity, (3) contact with a robotic part above a certain total momentum, (4) contact with a robot which is inexorable (that is, the speed may be slow, but the contact is dangerous because the robot may continue it regardless of dangerous consequences such as catching on clothing) (5) contact when a human body member is between the robot and an unyielding object such as a workbench surface or another robotic part.

In some embodiments, robotic movements are moreover targeted during planning to arrive at regions where collaborative interactions are expected to occur, based on past automatically recorded experience (e.g., experience comprising motion tracking data of human operators, and/or data regarding movements of the robot itself) with the operation.

For example, if (in recorded data documenting past performances of a particular operation) human operators tend to summon robotic assistance to a particular zone of their working area, robotic movement during that operation is planned to bring robotic assistance to that location, or as near to it as safety permits, proactively. Potentially, such anticipatory behavior helps to increase efficiency.

An aspect of some embodiments of the present invention relates to operator-specific customization of tasks performed in human-robot collaborative task cells.

In some embodiments, human operator performance of task action performed within is assessed; based, for example, on motion tracking of human operator body members, and/or analysis of robotic part movements. In some embodiments, assessment takes into account parameters of the task cell configuration, for example, operations performed sequence of operations, and/or placements of tools, parts, part feeders, and/or other items.

In some embodiments, the assessment is used to adjust tasks to better suit observed operator performance characteristics. For example, workers demonstrating particular facility and/or difficulty with a task and/or certain operations of the task are assigned to perform the task and/or certain operations more/less often. Optionally, a task is redefined on the basis of individual performance. For example, a task is divided into parts; each part being separately assigned to one or more operators, based, for example, on their individual facility with operations of those parts. Optionally, alternative predefined methods of performing certain actions of the task are made available; optionally adapted to the preferences, capacities and/or incapacities of particular human operators. For example, actions are adapted to the handedness, limb enablement, and/or level of physical coordination of an operator.

In some embodiments, customization applies to the prediction of operator actions. For example, different individual operators optionally perform the same operations using different placements and/or tempos of movement of their body members. In some embodiments, robotic members are moved differently for different human operators in order to accommodate these differences. Optionally, task cell layout of other items within the cell (parts and tools, for example) is adjusted for different human operators, e.g., to adjust for differences in size, reach, and/or vision.

In some embodiments, tasks are dynamically adapted in response to and/or for reduction of operator fatigue. Optionally, fatigue is observed, for example, by evaluation of pauses between and/or speeds during actions of the task as measured by motion tracking and/or a by features of robotic member movements related to human operator actions, such as decreased speed of operations, decreased tempo of switching between operations, and/or an incidence of movement adjustments, near-collisions and/or collisions. Optionally, fatigue is otherwise evaluated, for example, modeled to change as a function of number of operations performed, time on shift and/or since break, time of shift (for example, day or night), or another parameter.

As operator fatigue increases, in some embodiments, certain (e.g., more demanding) operations are optionally dropped from a task to be performed at a later time. Optionally, an operator is encouraged to periodically switch methods of performing a particular action or actions (e.g., within task process flows comprising a plurality of alternative routes), potentially reducing an incidence of fatigue and/or injury. Additionally or alternatively, an operator is encouraged to periodically change an order in which actions are performed.

An aspect of some embodiments of the present invention relates to human-robot collaborative task cells, each comprising a workspace including mounting points to which one or more robotic members are readily attachable, removable, and replaceable; allowing dynamic reallocation of robotic parts among a plurality of such task cells. In some embodiments, the workspace is defined by a workbench, and/or another arrangement providing access to parts and/or tools, mounting points for the robot, and a station allowing access to the workspace by body members of a human operator.

In some embodiments, task cells are designed to share robotic parts (such as robotic arms) among themselves, by providing mounting points (such as rails) to which robotic parts can be mounted at need, while also being easily removed for use elsewhere as necessary. Optionally, the mounting points provide power, e.g., to power robotic motion. Optionally, the mounting points provide data connections (e.g., for control). In some embodiments, robot data connections are wireless, which has the potential advantage of making transfer between task cells easier.

In some embodiments, a robotic task cell is provided for use within an assembly facility where a plurality of other robotic task cells is also present. Robotic arms are among the valuable capital equipment components of a task cell, so that there is a motivation to use them efficiently. There is also a cost to reconfiguring a whole task cell environment, for example labor and delay costs associated with tear down/restoration of a configuration, and/or revalidation of a restored configuration. It may be more cost efficient, in some instances, to leave idle task cells configured substantially as-is, and easing the moving of valuable robotic capital equipment to other task cells. Even with a single task cell which is being reconfigured for a new task, the need for robotic tooling is optionally dynamic—needing one robot, two or more robots, or no robot at all (for example if robotic services are irrelevant to a task). A task cell which can be easily converted to use more or less robotic equipment as needed for its currently configured task uses thus also provides a potential advantage for efficient use of equipment.

An aspect of some embodiments of the invention relates to displacement force sensitive mechanisms for robotic members (e.g., robotic arms). In some embodiments, robotic members (for example, of a collaborative task cell) are provided displacement force sensing mechanisms as part of one or more of the mounts and/or joints joining segments of the robot. Optionally, an excess of force exerted on the mechanism is sensed (for example, by sensing displacement of parts relative to each other and away from a default position), and motion of the robot stopped or reduced based on the sensed output. In some embodiments, this acts as a safety mechanism: first, because of the deflection which mechanically absorbs force, and secondarily by preventing excessive and/or sustained forces from being exerted by continued actuation of the robotic member.

In some embodiments, an axial joint joining two segments of a robotic member comprises two plates held pressed into an assembly, but kept elastically separated from one another, for example by springs positioned between them. In some embodiments, the elastic separation is by forces strong enough that ordinary motions of the axial joint and its load result in negligible plate deflection. Upon exertion of a sufficient force upon the load carried by the axial joint, however (e.g., due to a collision), the springs allow one of the plates to deflect relative to the other. The deflection is sensed (for example, by distance sensors located between the two plates), and optionally provided to a robotic movement controller. The controller in turn optionally aborts or restricts movement of the robotic member, based on input from the distance sensors. In some embodiments, the controller action is optionally to do nothing, for example, when the robot has been commanded to perform an action which could normally lead to a deflection, such as operation of a tool such as a screwdriver that involves pressing on a workpiece.

In some embodiments, a rotational joint of a robotic member comprises a mechanism configured to accurately transmit rotational force from a first part to a second part (e.g., a second part pressed up against the first part) when the joint is operated within some range of rotational forces. However, when excess force is exerted on the rotational joint, the first and second parts slip. In some embodiments, the slippage is sensed by a sensor that detects a relative change in position between the two parts. Optionally, the sensor output is used to signal a change in operation of the robotic joint: for example, to stop operation of the joint, and/or to reduce applied forces. Potentially, this acts as a safety mechanism to prevent injury when the arm unexpectedly encounters a resisting force, such as during a collision.

An aspect of some embodiments of the present invention relates to combined verbal and visual commands for human operator control of a robotic system.

In some embodiments, a robotic system is configured with a microphone and speech-to-text system for receiving and processing voice commands; as well as a position tracker operable to monitor the position of body members of a human operator. In some embodiments, commands to the robotic system are issued by the human operator by a combination of body member gestures and verbal commands. In some embodiments, the gesture acts to define a target for a robotic action, while the spoken part of the command specifies a robotic action. In some embodiments, the action is non-robotic, for example, display of information.

For example, recognized target selection gestures implemented in some embodiments include, without limitation, one or more of pointing with a finger or other body member, bracketing a region between two finger tips, framing a region by placement of one or more fingers, running a finger over a region, and/or holding a part of a piece up to a particular part of the workbench environment or robot that itself serves as a pointer, bracket, frame, or other indicator. Recognized verbal commands optionally include, for example: commands to direct use of a tool; designate bringing, storing and/or inspecting a component or portion thereof; display details of a target such as an image, specification sheet, and or inventory report; and/or start, stop, and/or slow operations by a particular robotic member.

In some embodiments, receptiveness of the robotic system to gesture/voice commands (optionally, either gesture or voice alone) is “gated”, for example by an activating word or gesture. In some embodiments, another command modality is used for gating, for example, use of a foot pedal.

An aspect of some embodiments of the present invention relates to planning of collaborative human-robot assembly tasks within a task cell. In some embodiments, requirements inputs are provided, for example, in the form of a bill of materials (BOM), tooling list, and list of assembly and/or inspection operations using and/or relating to those items. The list of operations is assigned to suitable combinations of predefined robotic-performed actions and human-performed actions, with tooling and BOM items assigned for use within each action as appropriate. The robotic system is programmed, and the human operator trained using output of the planning process. The plan also, in some embodiments, includes the definition of commands which control task flow between and/or within operations.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

### Human-Robot Collaborative Task Cells

### Collaborative Task Cell Components

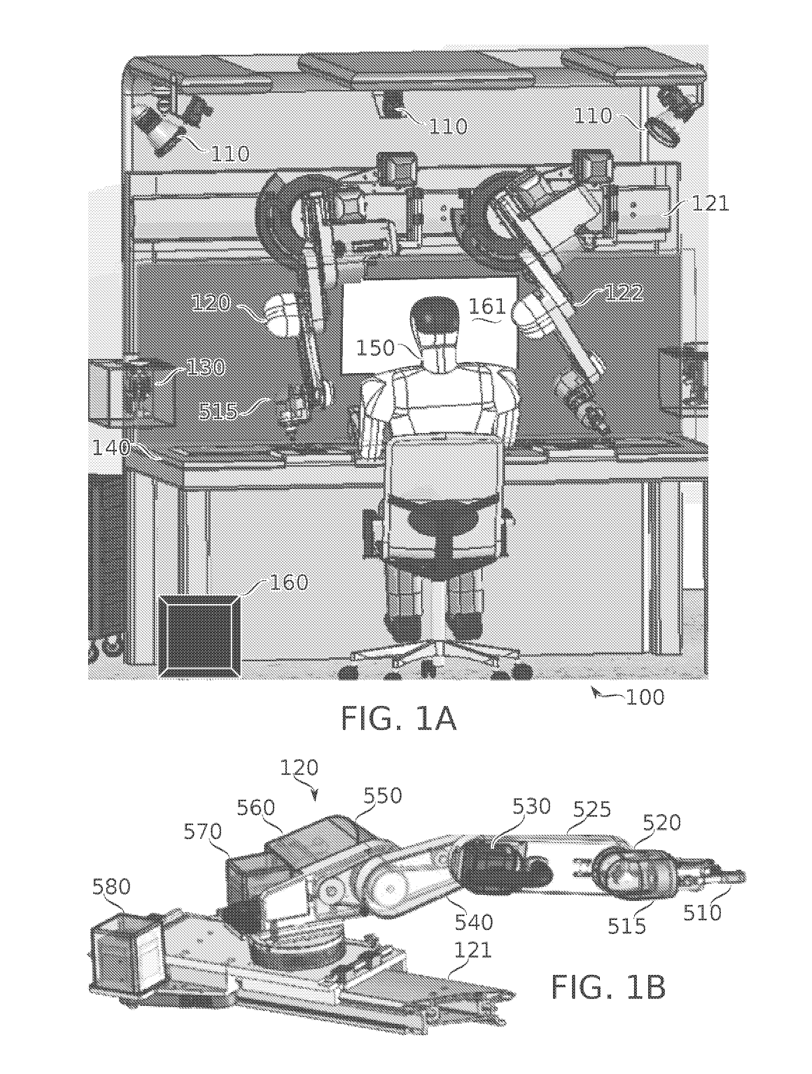

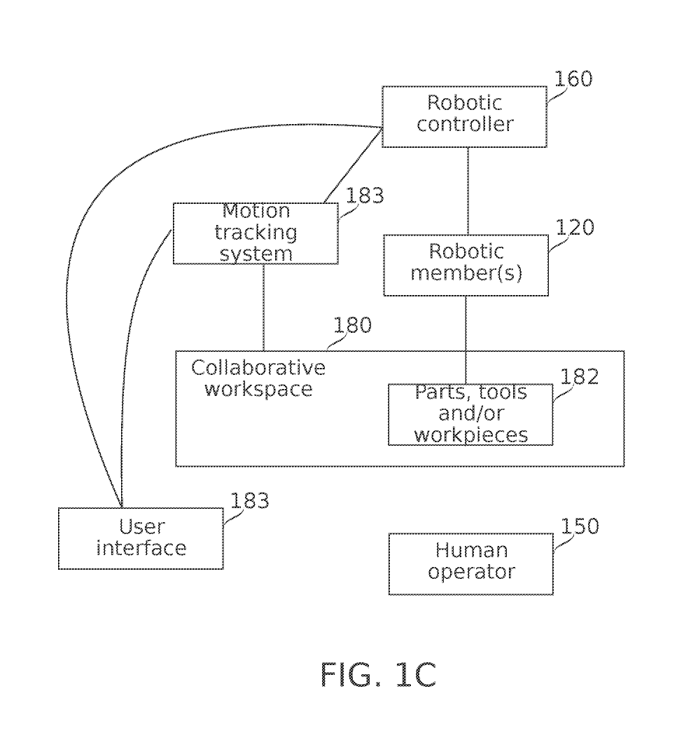

Reference is now made to FIG. 1A, which schematically illustrates a robotic task cell 100 for collaborative work with a human operator 150, according to some embodiments of the present disclosure. Human 150 approaches task cell 100 (e.g., sits at a front side of the workbench 140, as shown in FIG. 1A); for example, in order to perform collaborative robot-human assembly and/or inspection tasks. Herein, a robotic task cell 100 is also referred to as a “cell” or an “assembly cell”.

In some embodiments, task cell 100 comprises one or more robots 120, 122. In FIG. 1A, the robots 120, 122 are each implemented as a robotic arm. Robotic arms are used herein as an example of a robot implementation, however, it should be understood that in some embodiments, another robotic form factor (for example, a walking or rolling robot sized for roaming operation on the task cell tabletop) is used additionally or alternatively. Any suitable number of robots may be provided, for example, 1, 2, 3, 4, 5 or more robots. Robots 120, 122, in some embodiments, are placed under the control of a control unit 160, which is in turn integrated with sensing and/or task planning capabilities in some embodiments, for example as described herein. In some embodiments, control unit 160 is physically distributed, for example with at least some robotic control facilities integrated with the robot itself, with motion tracking facilities integrated with the cameras or a dedicated motion tracking unit, and/or another unit which is dedicated to supervising interactions among the various distributed processing facilities used in the task cell 100. Any control and/or sensing task performed by automatic devices within task cell 100 is optionally performed, in some embodiments, by any suitable combination of hardware, software, and/or firmware.

In the embodiment of FIG. 1A, robots 120, 122 are mounted to a supporting member of task cell 100, optionally one or more rails 121. In some embodiments, rail 121 is an overhead rail running horizontally at an elevation above the surface of a workbench 140. Additionally or alternatively, robots are mounted to a rail 121 located in another position, for example, along one or both sides of the task cell, to a working surface of the task cell (e.g., surface of workbench 140), or to another location.

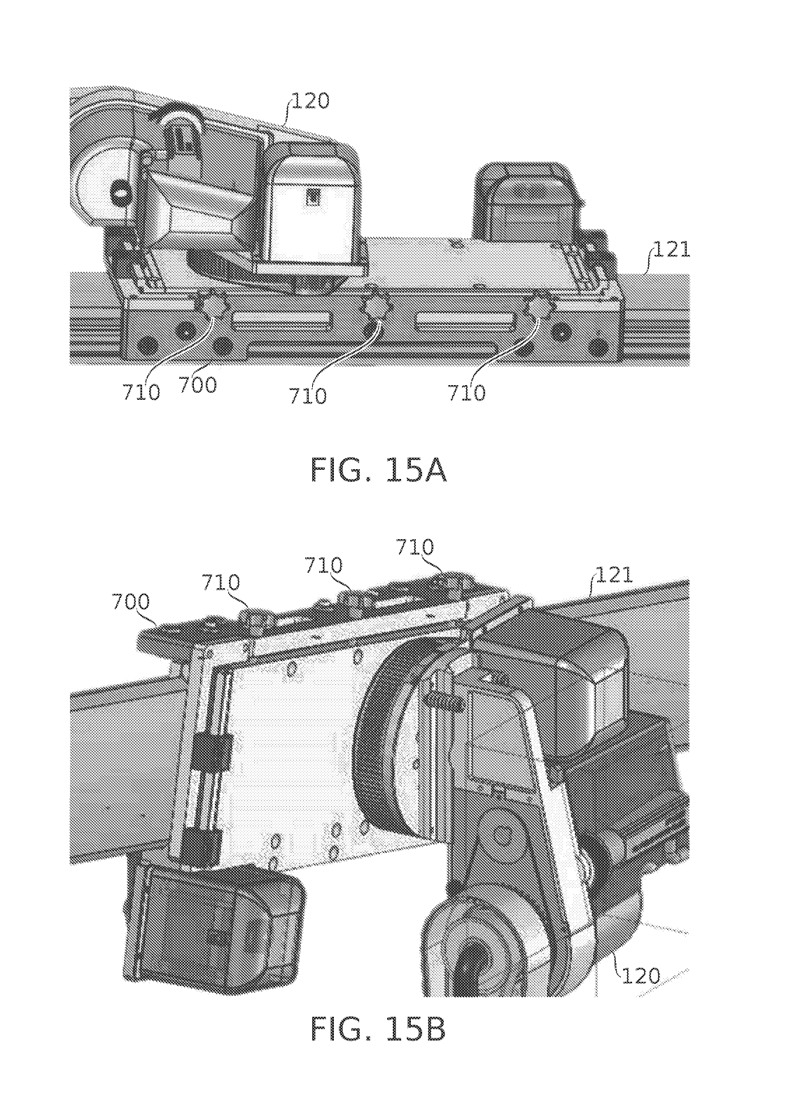

In some embodiments, robots are statically mounted (that is, they remain attached to a fixed location along rail 121 or at another attachment point provided by task cell 100). Optionally, a robot 120 is able to translate along rail 121, for example, using a self-propelling mechanism, and/or by engaging with a transport mechanism (e.g., a chain drive) implemented by rail 121. Optionally, a robot is able to translate in two or three dimensions (that is, the robot base is translatable in two or three dimensions); for example, translatable in two dimensions by being slidingly mounted on a first rail which is itself mounted to a second rail along which it can translate at an angle orthogonal to the longitudinal orientation of the first rail. Optionally, there is a third rail allowing translation along a third, orthogonal axis. In some embodiments, robots 120, 122 are configured to allow release and/or mounting from rail 121 (for example as described in relation to FIGS. 15A-15B, herein). This provides a potential advantage, for example for dynamic reconfiguration of a cell for different tasks, and/or for sharing of robots 120, 122 among a plurality of cells.

In some embodiments, robots are equipped with a single instrument (for example, a tool, sensor, material handling manipulator). Optionally, task cell 100 is equipped with at least one toolset 130 of one or more tools, which in some embodiments can be interchangeably connected to one or more of the robots 120. In some embodiments, a robot (e.g., robot 120) is configured to allow automatic exchange of tools of toolset 130 for use with a tool head 515. Optionally, a robot 120 changes its own tools. Optionally another robot 120 assists in tool exchange. In some embodiments, one or more robots (e.g., robot 122) are configured with a material handling tool, configured for use in gripping, holding, and/or transferring items within the environment of task cell 100. Manipulated items optionally comprise, for example, parts used in assembly, and/or tools for use by the human operator 150 and/or use by one of the robots 120 of the task cell 100. In some embodiments, a robot is equipped with a built-in camera or other sensing device, for purposes of quality assurance monitoring.

In some embodiments, imaging devices 110 (cameras) are operable to optically monitor working areas of the task cell 100. In some embodiments, imaging devices 110 image markers indicating positions and/or movements of body members (for example, hands, arms and/or head) of human operator 150. In some embodiments, monitored operator body member positions and/or movements are used in the definition of safety envelopes, for example, to guide motion planning for robots 120, 122. In some embodiments, control unit 160 performs analysis of images from imaging devices 110 and/or plans and/or controls the execution of movements of robots 120, 122. In some embodiments, an operator 150 interacts with control unit 160 via a user interface. For example, the user interface comprises display 161. For input to the user interface, a keyboard, mouse, voice input microphone, touch interface, gesture interfacing via imaging devices 110, or another input method is provided. Optionally, display 161 indicates current task status information, for example, a list of current task operations, indication of the current operation within the task, and/or indications of other operations which could be performed next. Optionally, display 161 shows currently planned and/or anticipated robotic motions and/or currently anticipated human motions, e.g., as superimposed annotations to a simulated and/or actually imaged view of the task cell 100. Optionally, the display indicates what operation the robotic system is currently carrying out and/or primed to carry out based on prediction

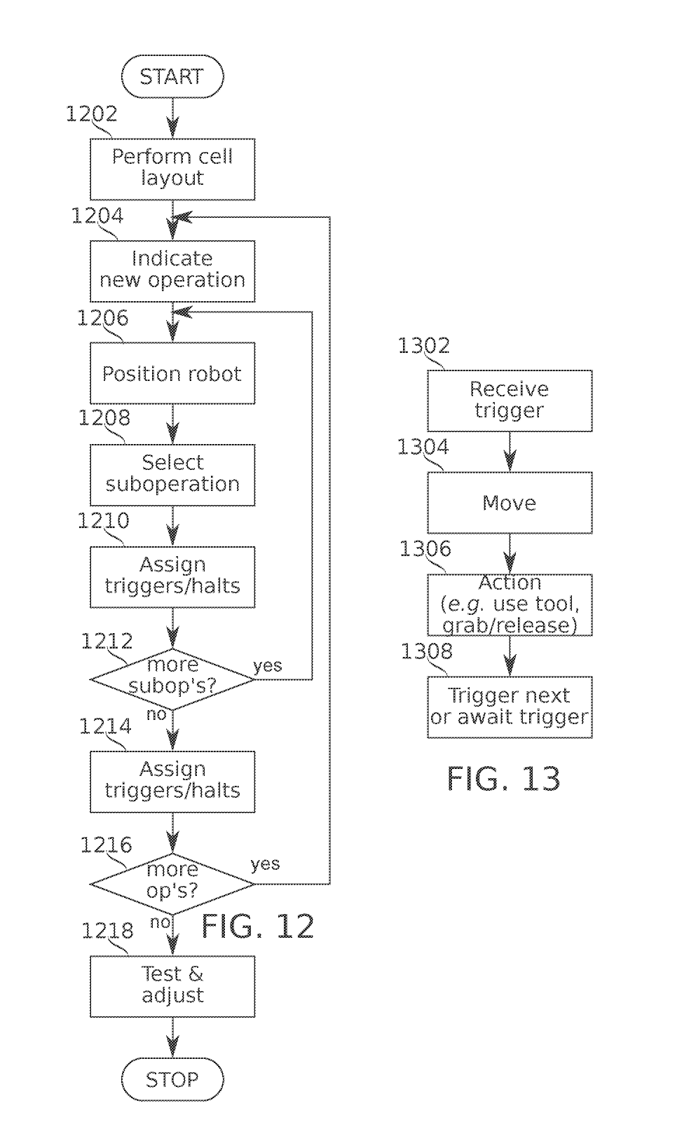

In some embodiments, the human operator 150 of a task cell 100 takes the role of manipulating one or more of the robots 120 directly via suitable input devices. Then other robots 120 in the task cell optionally operate in response to the directly controlled robot 120 as they would react in the case of an actual human operator 150. Optionally, direct manipulation of the robot 120 is performed as part of training a robot 120 on its part of a human-robot collaborative task, for example as described in relation to FIG. 12. Optionally, the human operator 150 is not even physically present at the task cell 100 itself, but operating one of its robots remotely.

Reference is now made to FIG. 1B, which schematically illustrates components of a robotic arm 120, according to some embodiments of the present disclosure.

Herein, general reference to robot 120 should be understood to be inclusive of any robot type suitable for use with task cell 100 and methods and sensing means described in relation thereto; for example, an robotic type comprising a robotic arm, and/or another type of robot such as a roaming robot. The robot may be off-the-shelf, and/or suitably customized for any particular requirements of the task (for example, provided with a manipulator suited to the manipulation of particular part shapes and/or sizes). Some particular aspects of specific embodiments of robot 120 are also described herein (e.g., in relation to FIGS. 1B, 10A-10G, 15A-15B, and 16A-16B), without limitation to the features of other potential embodiments. Where descriptions of examples herein make distinguishing reference to a plurality of robots (e.g., in relation to FIGS. 1A, 3A-3B, 5A-5C, 7, and 17A-17D), robot 122 designates a robot configured with a material handling tool, while robot 120 designates a robot configured with an exchangeable tool mounting. In all these cases, particular robotic configuration features mentioned should be understood to be exemplary and non-limiting with respect to what robots and robotic configurations are used, in some embodiments, as part of a task cell 100.

Components of some embodiments of robot 120 include tool head 515, including tool 510, which in some embodiments comprises a material handling tool (also referred to herein as a “gripper”), configured, for example, to grip, hold, and/or transfer items such as assembly components. In some embodiments, tool 510 comprises a tool for specialized operations, such as a screwdriver, soldering iron, wrench, rotating cutter and/or grinder, or another robotically operable tool. In some embodiments, tool 510 comprises a camera or other sensor, optionally configured to perform quality assurance measurements.

In some embodiments, an angle of articulation between arm section 540 and arm section 525 is set by the operation of arm rotation engine 530. Similarly, other arm rotating motors 550, 560 are optionally configured to rotate other joints. In some embodiments, an axis motor 570 is actuated to rotate the whole arm around an axis. Optionally, one or more motors 580 are provided to allow the robot to translate along a rail 121.

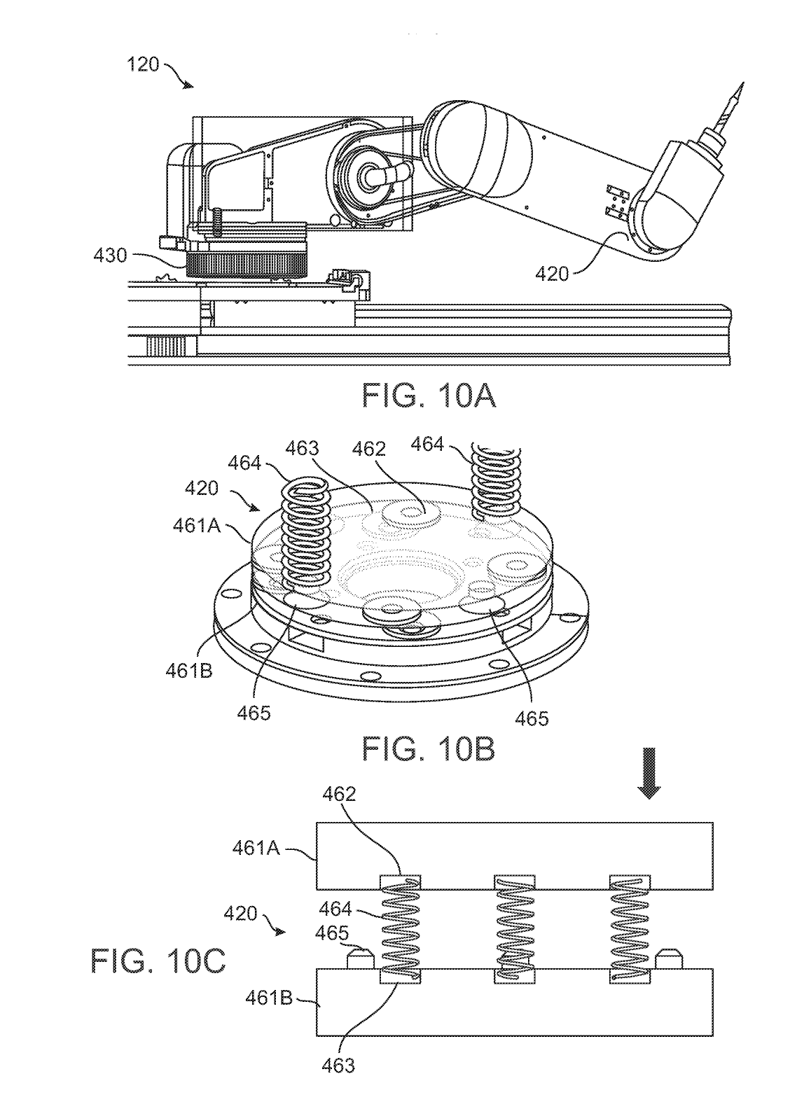

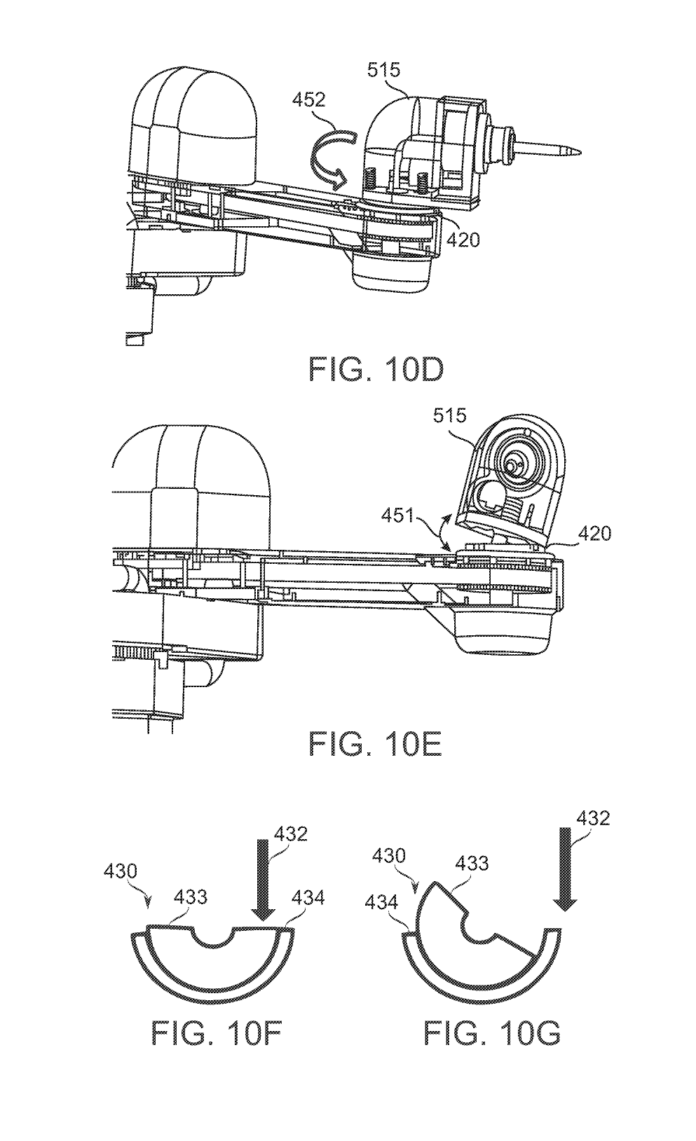

In some embodiments, tool head 515 is coupled to the rest of robot arm 120 via a displacement sensing mechanism 520, for example, a mechanism as described in relation to FIG. 10A-10G herein. Optionally, displacement due to unexpected force exerted on a part of the robot 120 (e.g., on tool head 515) triggers a sensor which indicates to a controller (e.g., control unit 160) that an over-force has been exerted. The controller optionally shuts down the arm, and/or reduces force, e.g., until the over-force sensing is eliminated. In some embodiments, another force-sensing safety mechanism is used. Optionally, for example, force that can be exerted by the robot 120 around one or more joints of a robot (for example, by arm rotation engine 530) is limited, for example by a clutch mechanism or slip mechanism.

Reference is now made to FIG. 1C, which schematically represents a block diagram of a task cell 100 (whole diagram), according to some embodiments of the present disclosure.

Robotic controller 160, in some embodiments, is configured to control robotic member(s) 120. Robotic controller 160 is optionally provided as an integral part of task cell 100; optionally, it is provided as a remote device, for example, network connected to other devices of task cell 100.

In some embodiments, robotic controller 160 is connected to user interface 183, which may comprise, for example, display 161, and optionally includes one or more input devices such as mouse, keyboard, and/or touch input.

In some embodiments, motion tracking system 183 includes imaging devices 110, and motion capture hardware and/or software used to drive the motion capture.

In some embodiments, collaborative workspace 180 comprises a workbench 140 and any parts, tools, workpieces, or other items which are part of the task cell layout.

Human operator 150 optionally interacts with the task cell 100 through the user interface 183, and by actions within collaborative workspace 180: including moving layout contents 182, by interacting directly with the robotic members 120 in the collaborative workspace, and/or indirectly with robotic members 120 or other system components by movements monitored by motion tracking system 183.

Task Framework for Human-Robot Collaboration

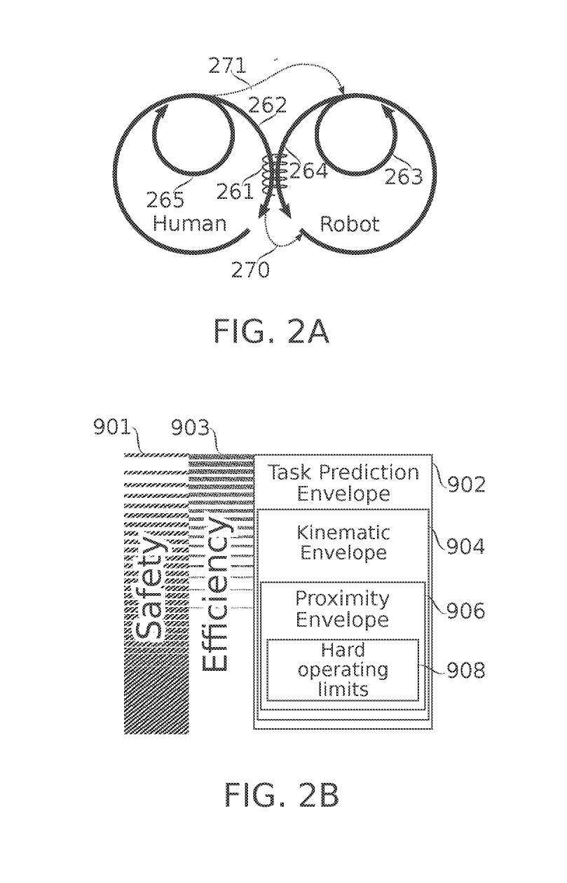

Reference is now made to FIG. 2A, which schematically represents a task framework for human-robot collaboration, according to some embodiments of the present disclosure.

Task activities (portions of tasks), in some embodiments, can be performed by either human and/or robot alone, or in human/robot collaboration. The curved arrows at the left side of FIG. 2A (activities 261, 265) represent cycles of task activities performed by a human operator 150 (cycling back to the next activity at the end of each arrow), while the arrows at the right (activities 263, 264) represent cycles of activities performed by one or more robots. In collaborative human-robot systems, some task activities include collaborative interaction 261 between human/robot activities (e.g. activities 262, 264). The collaborative interaction can involve direct human-robot contact, indirect contact (e.g., a human holding a tool to a part held by a robotic arm), and/or close proximity in time or space (e.g., a robot grasping a part that a human has just set dawn). Other activities 265, 264 may be carried out by each actor independently of the other, and optionally in parallel during some phases of the task. In embodiments where more than one robot 120 is used, the robots optionally interact with the human operator 150 separately and/or in coordination. A plurality of robots optionally also interact with each other (with or without human interaction), and/or optionally perform activities separately from one another.

FIG. 2A furthermore indicates human/robot collaboration which is driven, in some embodiments, by indications from the human operator 150 as to when and which activities are to be performed. Indication 271 from the human operator 150 indicates to the robotic system to initiate collaborative activity 264. Indication 270 indicates to the robotic system to continue after a collaborative activity with some new activity, either independent 263 or collaborative 264. Optionally, indications from the robot (not shown) signal new activities to the human. It is a potential advantage, however, for the human operator 150 to be the primary activity initiator, since it is with the human operator 150 that greater situational awareness and flexibility generally resides.

Collaboration issues addressed in some embodiments of the present invention include: (1) means and methods to let the human operator 150 effectively control robot activity selection without the control itself becoming an undue burden on the human operator 150 (who is often busy with their own activities), and/or (2) means and methods to protect the operator during interaction 261, aimed at reducing instances where safety behaviors (for example, avoidance and/or shutdown) of the robot interference unduly with overall task efficiency.

Human Control of Collaborative Tasks

In some embodiments of the present invention, the task environment is reduced to predefined operations, and methods are provided of chaining the predefined operations together to collaboratively accomplish a larger task such as assembly and/or inspection. Optionally, predefined operations are linked in a predefined order, and/or in a task flow-defining structure linking operations to one another via a plurality of procedure paths. Operation predefinition and/or structuring of operations into larger task(s) provide the potential advantage of allowing relatively simple indications from human to robot to trigger relative complex robotic activities. Potentially, this reduces control load on the human operator 150 and/or increases control efficiency.

In some embodiments, indications are optionally offloaded to be performed by the human operator's 150 non-task performing faculties, such as voice commands and/or foot pedal commands. In some embodiments, indications are performed by task-performing faculties (e.g., hands and arms). Optionally, they are defined in such a way as to make them flow from and/or into the performance of the activity itself. For example, gestures (e.g., reaching, pausing, picking up a tool, pointing, opening/closing the hand) can both indicate to the robot what activity is to be performed, and help position body members of the human operator 150 to perform the task.

### Movement Safety and Planning

Reference is now made to FIG. 2B, which is a schematic representation of different levels of safety and movement planning provided in a collaborative task cell, according to some embodiments of the present disclosure.

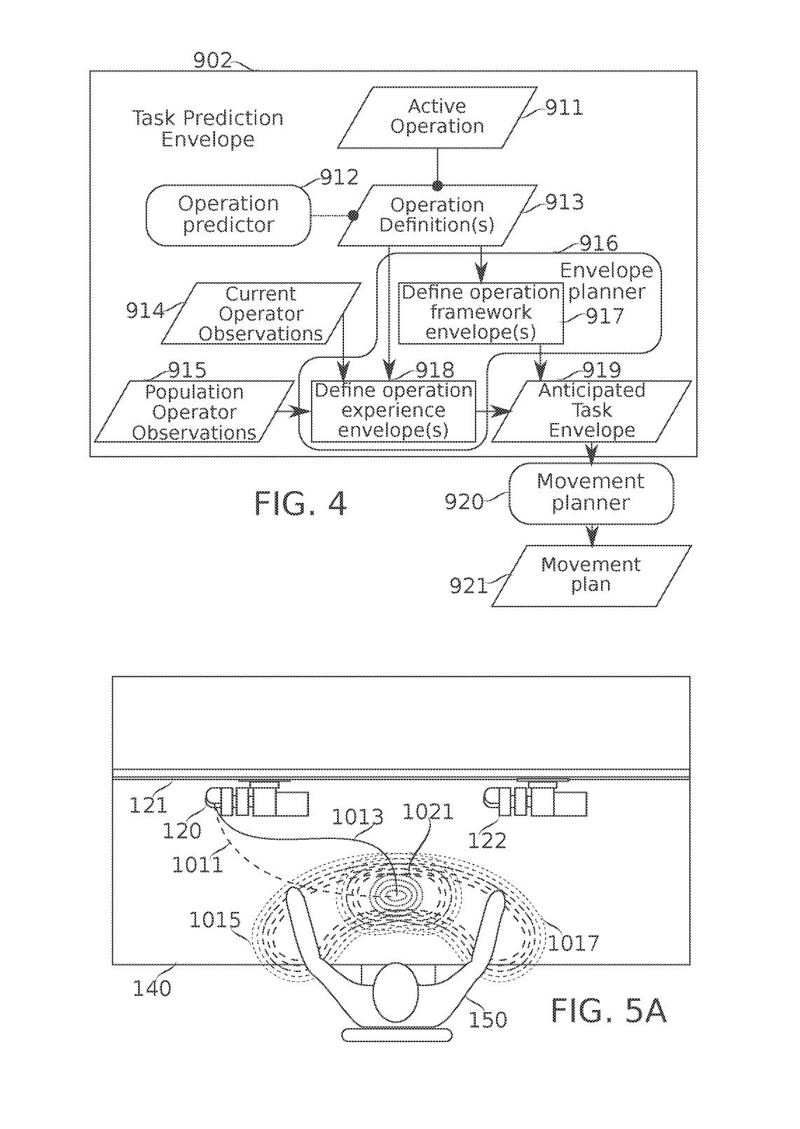

Nested blocks 902, 904, 906, and 908 indicate successive levels of generally increasing (with increasing nesting level) minimum expectation of safety 901, and generally decreasing (again with increasing nesting level) expectation of efficiency 903 at each successive safety and planning level. It is noted, however, that (particularly of the outer-nested levels) can encompass relatively large ranges of safety and/or efficiency, depending on how they are implemented; while the inner-nested levels are potentially more focused on ensuring safety (at least in part because they have reduced predictive capabilities). The nested levels of safety and planning are summarized next, and discussed individually in more detail in relation to FIGS. 4-9 herein.

Task prediction envelope 902, in some embodiments, provides a safety envelope which is based on a type of overall task and/or task operation “awareness”. Robotic motions are planned based in part on where a human operator's 150 body members are expected to be during the robotic motion. The expectation of human operator 150 body member positions is based, in some embodiments, on previous task operation definition and/or simulation. In some embodiments, the expectation is based on previous automatic observations of human operators (optionally, the specific human operator 150 currently performing the task) performing the task operation.

In some embodiments, the upcoming operation is known to the system, for example, because it is the next operation in a predefined sequence of operations. In some embodiments, the next operation is indicated to the system by the human operator 150, for example by gestures and/or spoken commands. In some embodiments, the human operator indication selects from among a restricted number of possible options defined by a process flow of the task. In some embodiments, the upcoming operation is at least sometimes at least somewhat indeterminate, but the system optionally still plans and execute motions as though the next operation will be, for example, the most frequently performed (or otherwise predictively preferred) next operation within the current task context.

It is noted that the task prediction envelope 902 is used, in some embodiments, for one or both of preventing moving a robotic part through areas where human body members are likely to be (i.e., the prediction envelope is used as a safety envelope), and targeting a robotic part to a position where collaborative interaction is expected to be indicated/requested by the human operator 150 (i.e., the prediction envelope is used as a targeting envelope).

Insofar as human body member positions are predictable in advance, task prediction envelope 902 potentially allows movement planning to avoid from the outset safety exceptions which could slow task performance. Since there is, in some embodiments, no absolute guarantee that a particular operator will always actually remain within the task prediction envelope 902, other planning/safety levels, optionally acting as fallbacks, either predict less far in advance (e.g., kinematic envelope 904, in some embodiments), and/or detect and react to the immediate situation (e.g., proximity envelope 906 and/or hard operating limits 908). Optionally, when one of the fallback levels is activated, the user is alerted by a visual and/or audible alarm, or another indication. Optionally, the obtrusiveness of the alarm depends on the degree of risk and/or task disturbance that activating a safety fallback level entails. For example, unexpected activation of the kinematic envelope is optionally handled by a minor motion correction which does not substantially affect performance; the alarm in this case may be relatively unobtrusive; e.g., enough to warn the user that they are pushing the system outside of its optimal predictive envelope operation. A safety exception requiring a full stop of motion, on the other hand, may produce an obtrusive (e.g., loud) alarm indication, for example, to alert the human operator 150 and/or others nearby of the occurrence of a possibly dangerous event.

Kinematic envelope 904, in some embodiments, provides a safety envelope which uses recent position tracking of body members of the human operator 150 to predict where those body members could and/or likely will be during a robotic motion. In some embodiments, the prediction is based on a motion model of the human operator 150, optionally including calculation of potential changes in acceleration and velocity at the different joints of the human operator's 150 body members. In some embodiments, the prediction is observation-based, e.g., finding past-observed situations which have similarity to a human operator's 150 current motions, and predicting where the motion is likely to continue to, based on what happened in those past-observed situations. There is optionally interaction, in some embodiments, between a purely kinematic envelope 904 and a task prediction envelope 902: for example, a task prediction envelope 902 is refined in real time (during movements of robot and/or operator) based on kinematics; and/or the current task scenario (current operation, for example) is used to select which kinematic envelope 904 is most relevant to current movements.

At the next level, a proximity envelope 906 is defined, in some embodiments, by sensors which detect unexpected proximity of a robotic member to an object (e.g., a body member of a human operator 150). Optionally, proximity as such is detected without localizing the position of proximity; for example, disturbance of an electrical field (e.g., capacitively sensed), magnetic sensing, and/or mechanical deflection of a projecting (e.g., whisker-like) and/or encapsulating (e.g., sleeve-like) member of the robot is detected by a change in a sensor value. Additionally or alternatively, proximity is detected, in some embodiments, by sensing proximity of a device worn by the operator. In some embodiments, proximity is detected optically (for example, using the imaging devices 110). A robot's safety response to proximity is optionally to treat it as a hard operating limit 908, but can also be less abrupt for example, a controller (such as control unit 160) can command the robotic arm to slow its movements, without halting entirely. If the spatial position of a body member in proximity to a robotic part is known (e.g., via optical sensing), movement of the robotic part is optionally changed to withdraw it from proximity.

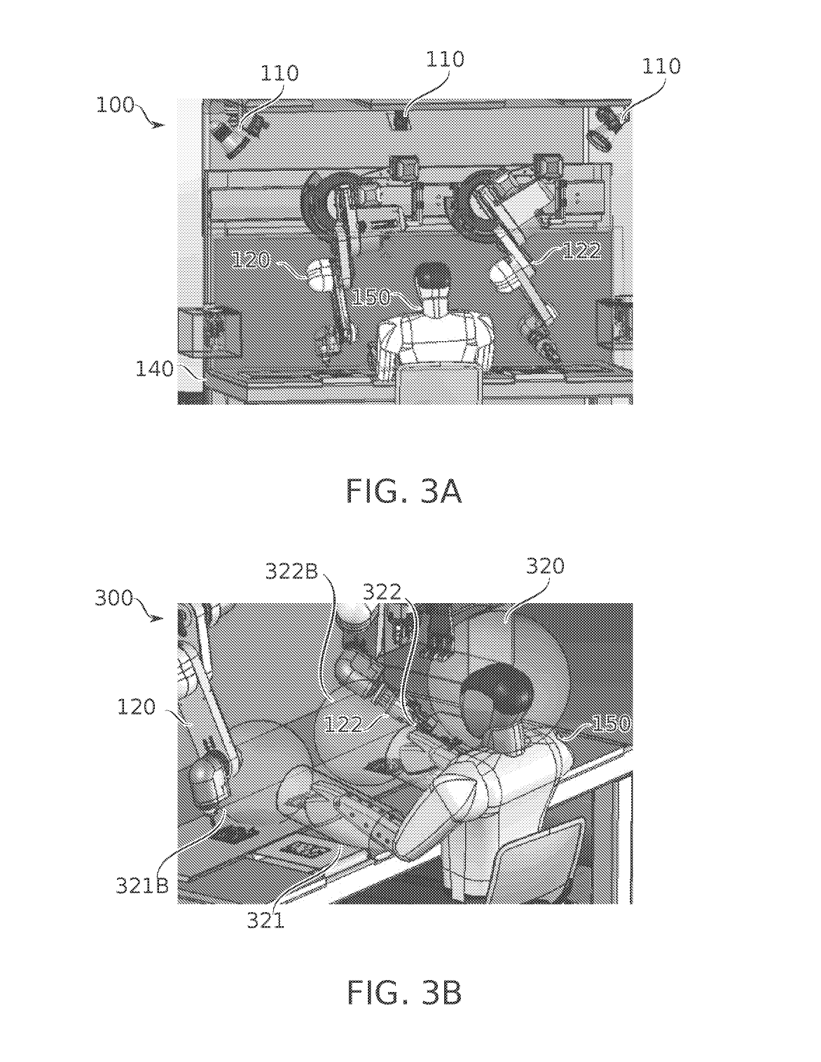

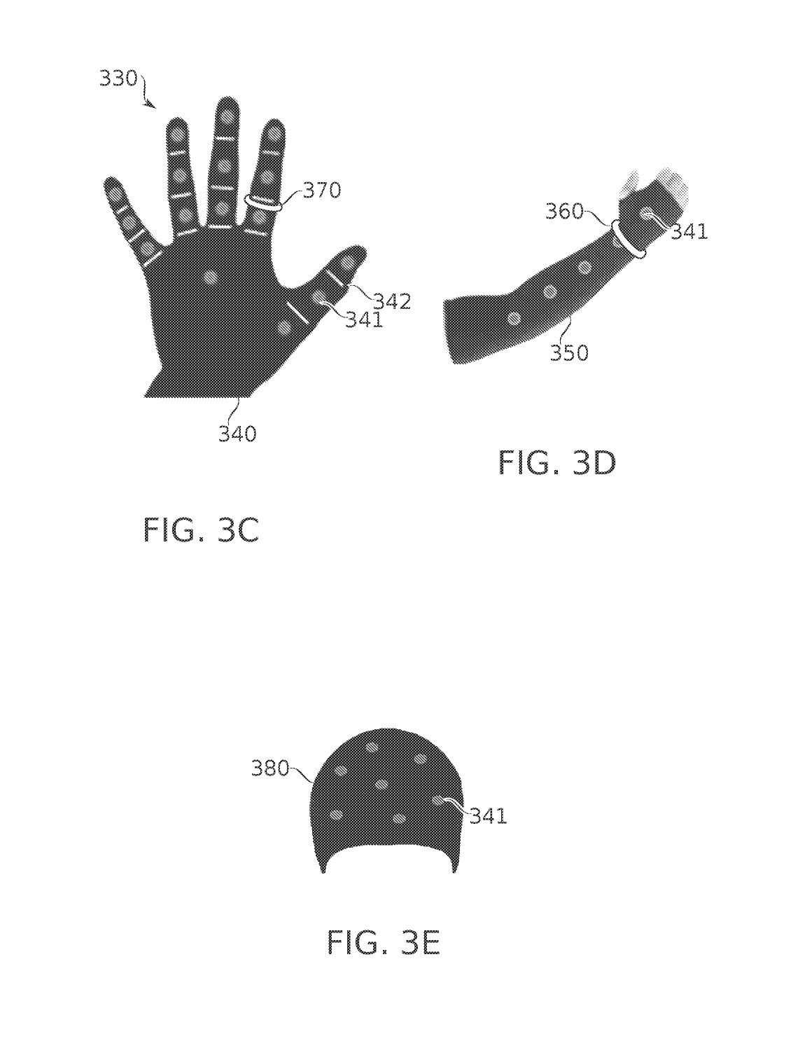

In some embodiments, any one or more of safety levels 902, 904, 906 uses optical tracking data of the operator. Examples of means and methods of optical tracking are discussed further, for example, in relation to FIGS. 3A-3E, herein.

At the deepest level shown are hard operating limits 908. Hard operating limits 908 comprise last-resort failsafe mechanisms of various types which are designed to prevent (partially or completely) operation of a robotic device as long for at least as long as a triggering condition is maintained. Triggers, in some embodiments, comprise one or more of emergency stop button presses, verbal halt commands (e.g., certain words and/or sound volume), sensors which detect potentially dangerous conditions, and/or mechanical design limits.

In some embodiments, a torque limiting mechanism such as a slip clutch is used to limit the amount of (potentially dangerous) force that can be applied through a robotic joint. Mechanisms for sensing relative displacement of robotic arm parts (e.g., due to unanticipated contact forces) are used in some embodiments, and described herein, for example, in relation to FIGS. 10A-10G. In some embodiments, robotic systems comprising such mechanisms are configured to disable or otherwise curtail robotic activity when the sensor indicates displacement; e.g., robot actuation is halted above some displacement threshold.

### Human Operator Position Monitoring

Reference is now made to FIG. 3A, which schematically illustrates devices used in position monitoring of body members of a human operator 150 of a robotic task cell 100, according to some embodiments of the present disclosure. Reference is also made to FIG. 3B, which schematically illustrates safety and/or target envelopes associated with position monitoring of body members of a human operator 150 of a robotic task cell 100, according to some embodiments of the present disclosure. Further reference is made to FIGS. 3C-3E, which schematically illustrate markings and/or sensors worn by a human operator 150, and used in position monitoring of body members of a human operator 150 of a robotic task cell 100, according to some embodiments of the present disclosure.

FIG. 3A emphasizes portions of task cell 100 optionally monitored by imaging devices 110 (cameras), including the table surface of workbench 140, human operator 150, and/or robots 120, 122. In some embodiments, monitoring by imaging devices 110 includes imaging of position-indicating devices worn by user 150, for example as described in relation to FIGS. 3C-3E.

FIG. 3B superimposes on a different view of task cell 100 representations of dynamically determined safety envelopes 320, 321, 322 around individual body members of the human operator 150; including envelope 320 around the operator's head, and envelopes 321, 322 around the operators arms and hands. Optionally, safety envelopes are additionally or alternatively used as target envelopes for some robotic motions, potentially facilitating human-robot collaborative work. For example, a safety and/or target envelope extends into areas within the (predicted and/or potential) near-future reach of body members of the operator; illustrated e.g., by envelopes 321B and 322B. The envelopes are defined, in some embodiments, based on processing of images from imaging devices 110 to determine the positions (e.g., in three dimensions; optionally in two dimensions) of the operator's respective body members. Zones of several types defined based on body member position sensing are described, for example, in relation to FIG. 2B, and FIGS. 4-9 herein. Optionally, envelopes of any of the described types are managed simultaneously, for example, safety envelopes are avoided by robotic movements while one or more appropriate targeting envelopes are sought. Moreover, there may be a plurality of safety envelopes protecting a particular human operator 150 body member at any given time, e.g., a task prediction

In some embodiments position sensing is based on sensors and/or indicators worn by the human operator 150; for example, worn on hands, arms, fingers and/or head as part of a glove 340, ring 370, sleeve 350, bracelet 360, and/or headgear 380 of FIGS. 3C-3E. A potential advantage of such sensors and/or indicators is to reduce the calculation complexity of human motion tracking to the problem of tracking the motion of easily identifiable (e.g., high-contrast) markers.

Indicators 341, 342, in some embodiments, comprise optically distinct markers (that is, distinct from other objects in the scene, for example, due to reflectance/fluorescence properties, and/or due to active light emission). Optionally, ring 370 and/or bracelet 360 are optically distinct from other scene objects e.g., in their reflectance/fluorescence properties, and/or due to active light emission. Optionally, indicators are distinguishable also from one another, for example, by their particular pattern (optionally including pattern of arrangement with respect to one another), orientation, and/or coloration.

Optionally, indicators comprise light emitting diodes (LEDs). Optionally, a special light source (e.g., UV light) is provided to induce fluorescence, and/or to induce reflectance at specified wavelength(s), optionally wavelengths at visible, ultraviolet and/or infrared wavelengths. Imaging devices 110 are configured to send images of the indicators to control unit 160 or another device configured to process the images, detect the optical distinction, and determine therefrom the position (e.g., in position in 3-D space, and/or optionally a 2-D space, for example defined with respect to the plane of the workbench's 140 main working surface) of the indicators—and by extension, of the body member which wears them. The subsystem of task cell 100 used for analyzing operator body member position is optionally a motion capture system comprising cameras 110, control unit 160. Optionally, the positions detected are used in the calculation of dynamic safety envelopes used by control unit 160 to govern robotic motion. Optionally, the positions detected are used to determine motion targets, e.g., to bring a part to a location where it is anticipated that a human operator 150 will indicate a collaborative operation (for example, as described in relation to FIG. 4).

In some embodiments, indicators comprise non-optical emitters and/or receivers of radiant energy, for example, radio-frequency energy. The radio-frequency energy is optionally sensed by parts of the robot to indicate proximity. For example, in some embodiments, RFID tags are worn, and sensed upon sufficient proximity to an RFID reader carried by a robotic member. In some embodiments, sensors are worn incorporated into any of glove 340, ring 370, sleeve 350, bracelet 360 and/or cap 380, to indicate movements and/or position of body members of the human operator 150; for example, inertial sensors, or electromagnetic field sensors that detect, e.g., proximity of electrical fields generated from robotic parts.

In controlled assembly environments, human operators often garb in special clothing; for example a gown such as a clean room suit to control contamination. Optionally, indicators 341, 342 are added to the clothing itself, and/or manufactured with worn items (gloves, sleeves, caps) made of material that is compatible with contamination control and/or other assembly room requirements. In some embodiments, indicators 341, 342 are applied to standard assembly area clothing, e.g., as stickers.

Task Prediction Safety and/or Targeting Envelopes

Reference is now made to FIG. 4, which is a flowchart schematically representing planning of robotic movements based on predictive assessment of the position(s) of human operator 150 body members during the planned movement, according to some embodiments of the present disclosure.

In some embodiments of the invention, tasks are broken down into operations; each operation may itself comprise a series of one or more actions (robotic and/or human) which together complete the operation. A typical collaborative human/robot operation comprises one or more robot movements, movements of the human, and one or more further actions; for example, operation of a tool, placing of a part, and/or inspection of a part. Operations may also be only on of the human, only of the robot. Robot and human operator 150 may perform different operations simultaneously. Descriptions in relation to FIGS. 12-14, herein provide examples of how tasks, operation, and their actions may be defined. Operations of a task optionally occur in predefined sequences. Optionally, operation order is variable, for example, the next operation is selectable after some previous operation from among a predefined set of options. Optionally, operation order is selected freely by an operator from among a library of available operations.

In some embodiments, automatic determination of a task prediction envelope (block 902) results in the production of an anticipated task envelope 919. The anticipated task envelope 919 in turn is optionally used by movement planner 920 (optionally along with other information, for example, human operator indications and/or other safety envelope calculations and/or data) to produce a movement plan 921. Movement planner 920, in some embodiments, is implemented as a module of control unit 160. The movement planner 920, in some embodiments, uses the anticipated task envelope 919 to determine what areas to generally avoid during robot movements, and when. Optionally, movement planner 920 also plans robotic actions such as tool and/or gripper actuations as part of movement plan 921 to avoid violating safety envelope considerations. Optionally, the anticipated task envelope 919 also is used by the movement planner to select and/or refine movement targets, and/or to plan tool actuations. For example, a tool having a brief warm-up or spin-up period is optionally planned to begin this period ahead of time, based on when it is anticipated that the tool will actually be used.

On the input side, creation of the anticipated task envelope 919 optionally begins with the receiving of an indication of the currently active operation 911. Optionally, the indication originates from the human operator 150; optionally the indication is received after initial processing, such as speech and/or motion processing, to convert the indication to a machine-usable form) Additionally or alternatively, there may be an operation predictor 912 which provides an indication of a predicted operation about to be performed. Operation predictor 912, in some embodiments, is implemented as a module of control unit 160. Prediction, in some embodiments, is on the basis of the task being predefined as a fixed sequence of operations. In some embodiments, prediction is statistical, e.g., based on what has usually been the next step, optionally weighted by the relative advantage of beginning planning and/or movement anticipatorily, considering the possibility of anticipating incorrectly. In some embodiments, prediction is based in implicit indications; for example, where an operator's body members are and/or are moving to, possibly in anticipation of performing the next operation. Potentially, this allows robotic movements to be planned and optionally even begun before the human operator 150 has indicated them, and/or to allow the robot to operate autonomously for a period of time. Operation predictor 912 operates, in some embodiments, on the basis of a task plan, for example as described in relation to FIGS. 12-14. It is to be understood that if the prediction of operation predictor 912 turns out to be incorrect (e.g., if it is overridden by the human operator 150), that the movement or other action can be aborted, and a different one planned and initiated.

Block 913 represents a set of one or more operation definitions, which are selected from based on the inputs of either the active operation 911 or the output of the operation predictor 912 to provide an input to envelope planner 916. Envelope planner 916, in some embodiments, is implemented as a module of control unit 160.

Examples of operation definitions are described, e.g., in relation to FIGS. 12-14. In some embodiments, the operation definition provided to envelope planner 916 comprises information such as descriptions of movement waypoints and/or targets. Descriptions can be high-level (e.g., part tray designations and/or identified assembly zones), or low level, for example, specified as particular 3-D coordinates. Waypoints and/or targets are optionally dynamically moving in their own right; for example, the target may be defined as a position in front of a human operator's 150 (possibly moving) hand. There can also be associated with the operation indications of how quickly movements should (or may) be carried out and/or how precisely. In some embodiments, the operation definition specifies when and/or where tools should be activated. Intra-operation events, for example, events that trigger the next action in the operation, and/or terminate the current one, are optionally specified in the operation definition. Optionally, the operation definition includes metadata relating to collaborative aspects of the operation. This information can be used, for example, to determine which safety envelopes should be active or inactive at any given time, with what threshold of activation, and/or if a safety envelope is allowed to be deactivated by the human operator, e.g., to allow collaboration to occur.

Optionally, the operation definition includes an indication of what human operator movements are expected to occur during the operation, based on assumptions, simulations, and/or a previous history comprising position measurements. In some embodiments, at block 917, indications of human movement needed to complete the operation are converted by envelope planner 916 into an operation framework envelope. In some embodiments, at block 918, indications of human movement needed to complete the operation are combined with previously experienced position observations 914, 915 of operators to produce an operation experience envelope. Optionally, one of these is provided as anticipated task envelope 919. Optionally, the two envelopes are combined to produce anticipated task envelope 919.

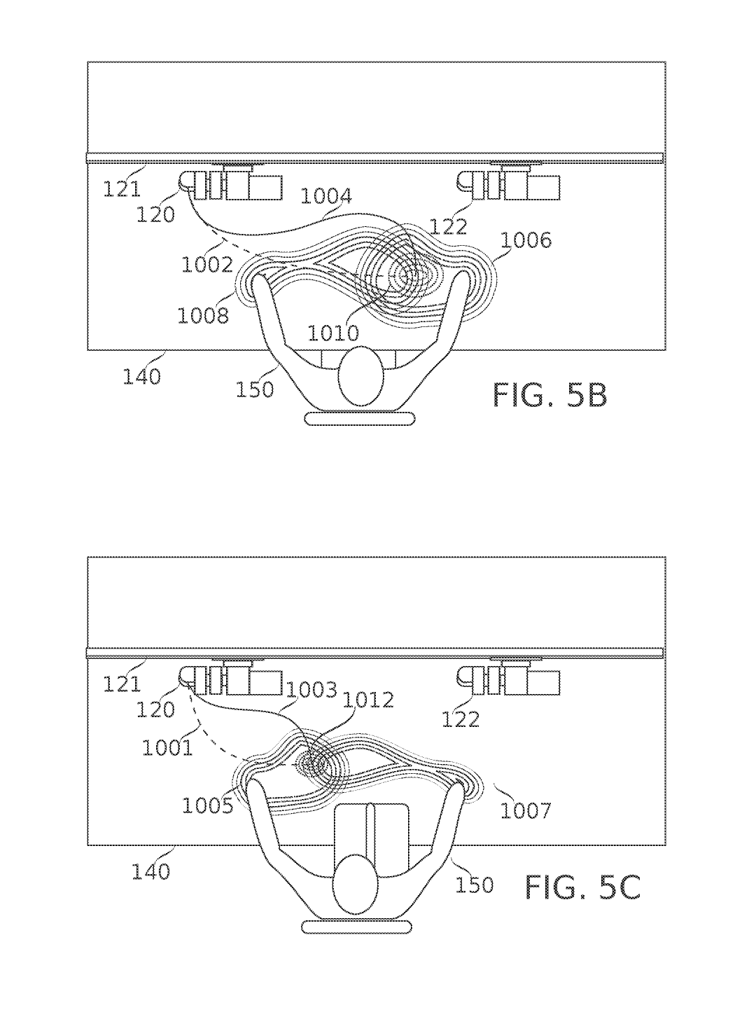

Reference is now made to FIG. 5A, which schematically represents zones of anticipated position 1015, 1017 of body members of a human operator performing a task operation in collaboration with a robot 120, along with a predicted zone of collaboration 1021, according to some embodiments of the present disclosure. Robot 122, rail 121, and working surface of workbench 140 are also shown for reference.

In some embodiments, a movement expectation is based on a priori assumptions about how the human operator will perform a given operation (in this case, a priori means assumptions made without the benefit of motion capture position measurements, as described in relation to FIGS. 5B-5C). Optionally, such assumptions are generated from simulations, for example of the range of movement of a simulated human operator, and/or from detailed simulations of a simulated human operator during computerized simulation of the task. The relevant operation may be selected, for example, because it is the next operation in a predefined sequence of operations or other process flow structure; and/or because it is indicated to the system explicitly or implicitly by the human operator.

The assumptions are optionally defined by an engineer (a process, industrial and/or manufacturing engineer, for example), e.g., working with the assistance of a computer aided design (CAD) program. Optionally, the a priori assumptions are based on simulations, wherein movements of a human operator are predicted, for example using a simulated human being performing as an agent in the task. Optionally, the simulations include parameters to simulate human motion variability, e.g., partially randomized parameters, parameters varied within suitable ranges, or another method. The movement expectation is optionally defined as a path, family of paths, and/or region in which movement is expected to occur. Movement expectations can be defined statically, and/or as a function of time.

In FIG. 5A, movement expectations are shown defined as zones; zone 1015 defined for movements of the left hand, and zone 1017 defined for movements of the right hand. Zone 1021 represents a notional collaboration zone within which collaborative actions between robot 120 and human operator 150 are expected to take place. In some embodiments, one or more additional motion zones are defined, for example for the operator's head (which could, for example, be brought into the collaboration zone in order to better inspect the work). The zones are represented with contour lines, which optionally represent zone sub-regions of different probability of occupation, dwell times, or another weighting statistic. Optionally, zones are defined simply as including a path or region or not, without reference to relative weightings.

Motion paths 1011, 1013 represent two different possible approach paths that a tool end of robot 120 could take in order to reach zone 1021. Motion path 1011 is optionally a path which could be preferred (e.g., the time-optimal path), in the absence of safety requirement interference. Motion path 1011 intrudes early into the expected human motion zone 1015 of the left hand, and remains there. Motion path 1013 represents a different path which could be produced by movement planner 920 in view of human motion zone 1015. Path 1013 avoids entering zone 1015 until near its target. Optionally, traverse along path 1013 is also defined to use slower movements in places where human movement is expected. In some embodiments, planning of path 1013 takes into account different weightings of zone sub-regions. Since, in some embodiments, the anticipated task envelope 919 is not relied on exclusively for safety, it may be preferable for the initial motion plan to be selected to avoid potential collisions only an “acceptably low” fraction of the time (e.g., 50%, 80%, 85%, 90%, 95% expected chance of no collision). Robotic action to avoid potential collision events that then occasionally arise is optionally induced by the activation of fallback safety envelopes based on other considerations.

It is noted that the definition of collaboration zone 1021 potentially becomes a kind of self-fulfilling prediction, in that the human operator 150 may reach for that zone because they perceive that this is where the robot 120 is moving to. Optionally, however, e.g., if the human's motion-tracked hand were used to define the robot's 120 target zone, the actual path of the robot 120 would be deviated from the originally planned track 1013 to reach the target zone, wherever it moves to. In some embodiments, a history of such deviations from a priori human operation movement expectations is used to allow adapting of initial planning, for example as now described in relation to FIGS. 5B-5C.

Reference is now made to FIG. 5B, which schematically represents zones of anticipated position 1008, 1006 of body members of a human operator performing a task operation in collaboration with a robot 120, along with a predicted zone of collaboration 1010, according to some embodiments of the present disclosure. Robot 122, rail 121, and working surface of workbench 140 are also shown for reference.

In FIG. 5B, the zones of position 1008, 1006, and 1010 are based on a dataset of previous operator observations 915, wherein the dataset comprises measurements of operator body member position during performance of the operation, for some population of operators. In some embodiments, the measurements were previously made using a motion capture system, for example, using imaging devices 110, and optionally one or more of the indicators and/or sensors described in relation to FIGS. 3C-3E. Optionally, the dataset comprises body member positions simulated for a simulated human operator; for example during pre-deployment development of the task, and/or in simulations run for task refinement/troubleshooting purposes after deployment of the task.

In the case shown, the population-level observations appear to reflect movements by a right-handed operator preferring to work slightly to the right of body center, with assist from the left hand. Again, contour lines optionally indicate weightings related to observed movements, for example, probabilities, dwell times, instance counts, or another weighting statistic. Following this pattern, in some embodiments, envelope planner 916 optionally defines an operation experience envelope at block 918 which is less restrictive of movements near the left-hand side of the human operator than for the case of FIG. 5A. Target zone 1010 potentially is defined more realistically than in the case of FIG. 5A, so that fewer final corrections (to avoid collision and/or to put the robot 120 where it is needed) may be needed.

Again, robot motion path 1002 represents a notional “optimal path” in the absence of collision avoidance restrictions. Robot motion path 1004 represents a human-motion adjusted path produced, for example, by motion planner 920.

Reference is now made to FIG. 5C, which schematically represents zones of anticipated position 1005, 1007 of body members of a human operator performing a task operation in collaboration with a robot 120, along with a predicted zone of collaboration 1012, according to some embodiments of the present disclosure. Robot 122, rail 121, and working surface of workbench 140 are also shown for reference.

In the case shown, the observations on which the zones of position 1005, 1007 and target zone of collaboration 1012 are based are observations of the particular and current human operator 150 performing a task. In distinction to the data available from the general population of human operators 150 (shown in FIG. 5B), the current operator appears to prefer left hand-dominant actions, and with less variability than the general population shows. Now optimal (collision-indifferent) path 1001 is shorter (since the zone of collaboration 1012 is nearer to the base of robot 12), as is collision-avoiding path 1003 which takes expected human body member positions into account.

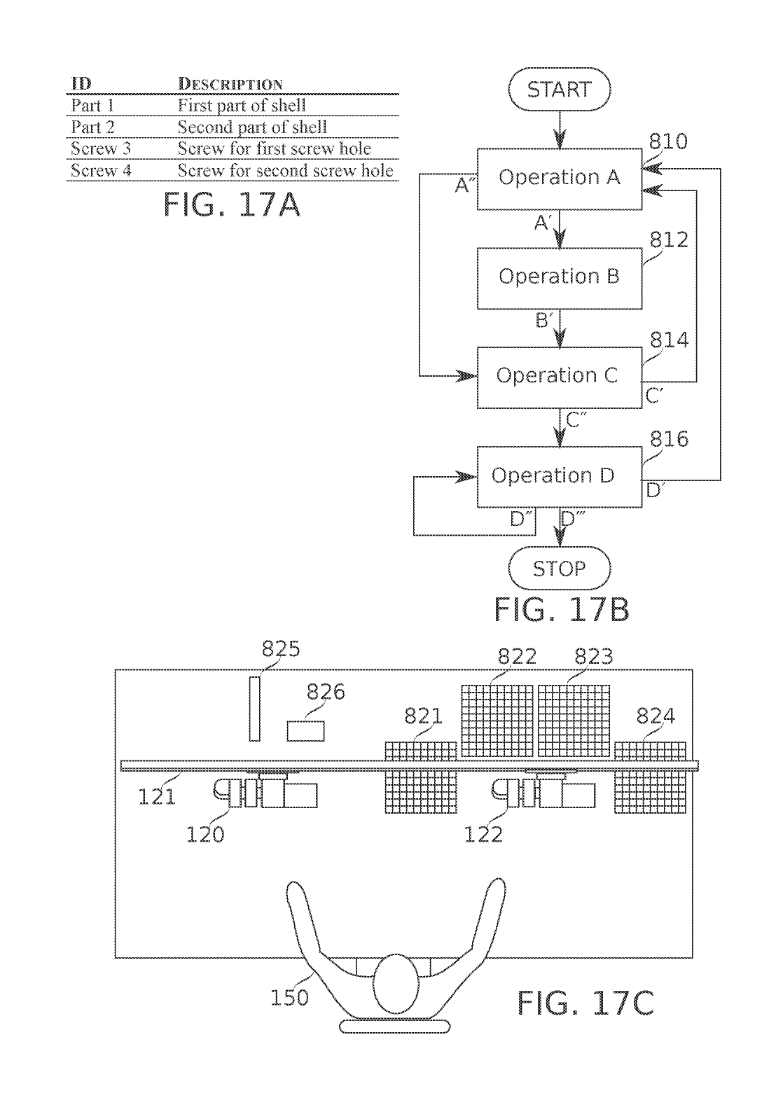

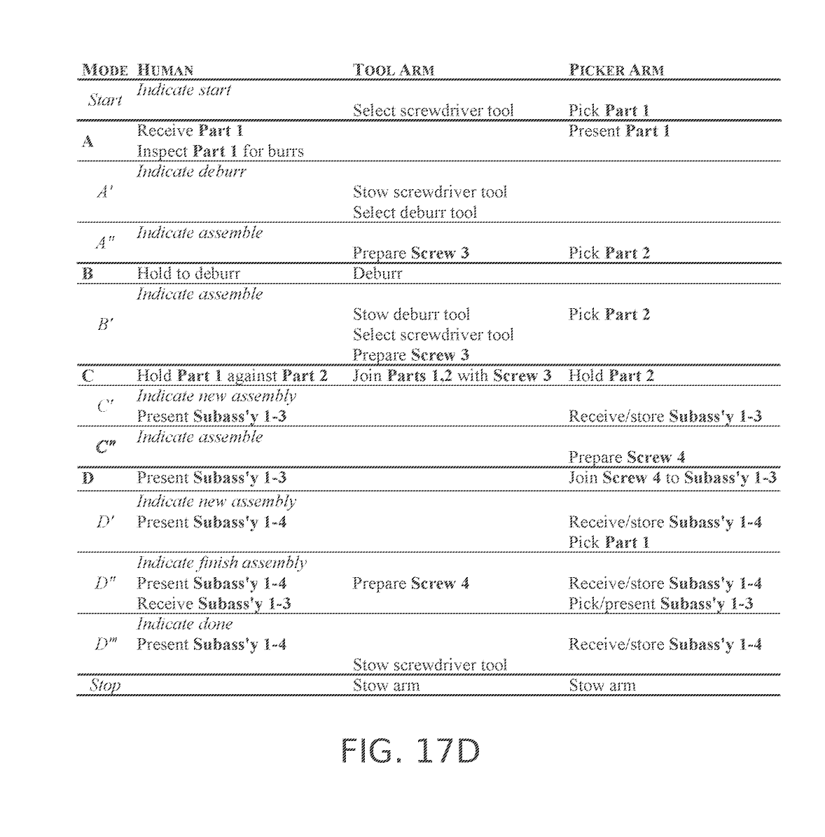

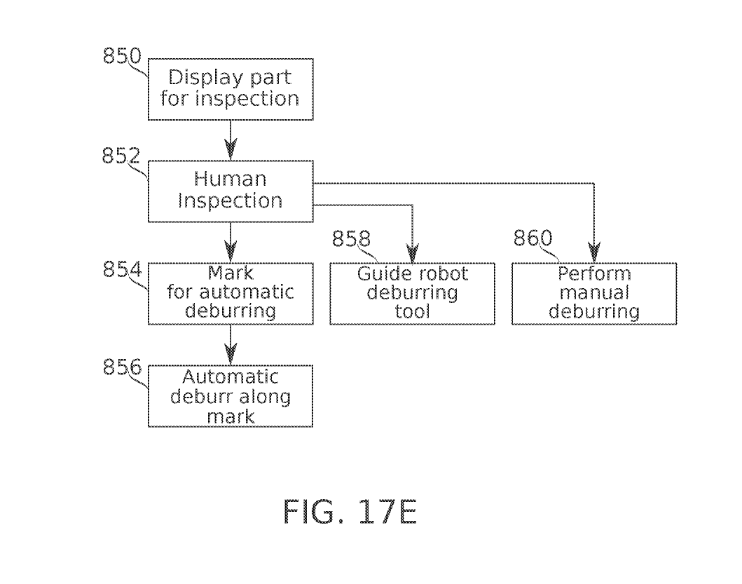

Another reason for inter-operator differences, in some embodiments, is differences in which operation follows which. A task supporting multiple pathways between operations is described in relation to FIGS. 17A-17D. Potentially, different operators (or even the same operator at different times) could follow different pathways through such a task, and the different pathways could lead to different human operator motion histories.

It should be understood that the different types of prediction basis described in FIGS. 5A-5C are optionally all used to some degree in some embodiments of the invention. The different types of position indications may, for example, be combined by an arrangement of weightings; for example, with individual data being weighted higher (more important) than population data, and both being weighted higher than a priori assumptions. In some embodiments, different types of position indications are weighted so that they effectively form fallbacks to one another: e.g., individual human operator data is used if available; population data is used if not, and until there is population experience, a priori human motion assumptions are relied on.

However, the a priori assumptions could be given the largest importance, for example in order to encourage human operator work practices that permit optimal robot motions, with the deviations optionally being taken into account enough to increase efficiency, but not enough, for example, to drive the collaboration target zone into a sub-optimal position.

In some embodiments, only a part of a motion tracking history is used; for example a time-limited motion tracking history that uses only the most recent few operation performances to predict motion.

In some embodiments, actual experience with an operation may include discovery of a more efficient set of human and/or robotic motions than was originally available. Discovery may be enabled, insofar as robotic actions may be set to adapt to changes in individual human operator behavior. Optionally, such a discovery is taken advantage of by selecting the task prediction envelope to be more like the most efficient human motions known. Optionally, operators are explicitly trained to follow this preferred motion envelope. Potentially, the robotic motions become a cue to the human operator 150 as to what motions they should perform: the human operator 150 may tend to reach toward the more efficient target collaboration zone that the robot 120 seeks, and/or may tend to avoid zones that the robot moves through. Again, even though this could result in an increase in “near misses” while the human is learning to modify their own behavior, a hierarchy of safety zones optionally provides fallbacks that help preserve overall human operator safety.

Optionally, parts of an individual user's task prediction envelope which appear to induce the robot to follow a sub-optimal (e.g., slower than necessary and/or targeted) motion path are indicated to a human operator 150 (e.g., by display on a user interface screen 161). The human operator 150 optionally may begin avoiding those areas, potentially reducing their weight in robotic path planning. Optionally the human operator 150 is given the option of trimming a problem area from their motion history so that the robot can return to a more preferred motion path. Optionally, the population history can be similarly pruned; for example, to remove the effect of motions in the history which are unlikely to be repeated, and/or are infrequent enough that it is preferable to rely on fallback safety mechanisms.

Kinematic Safety and/or Targeting Envelopes

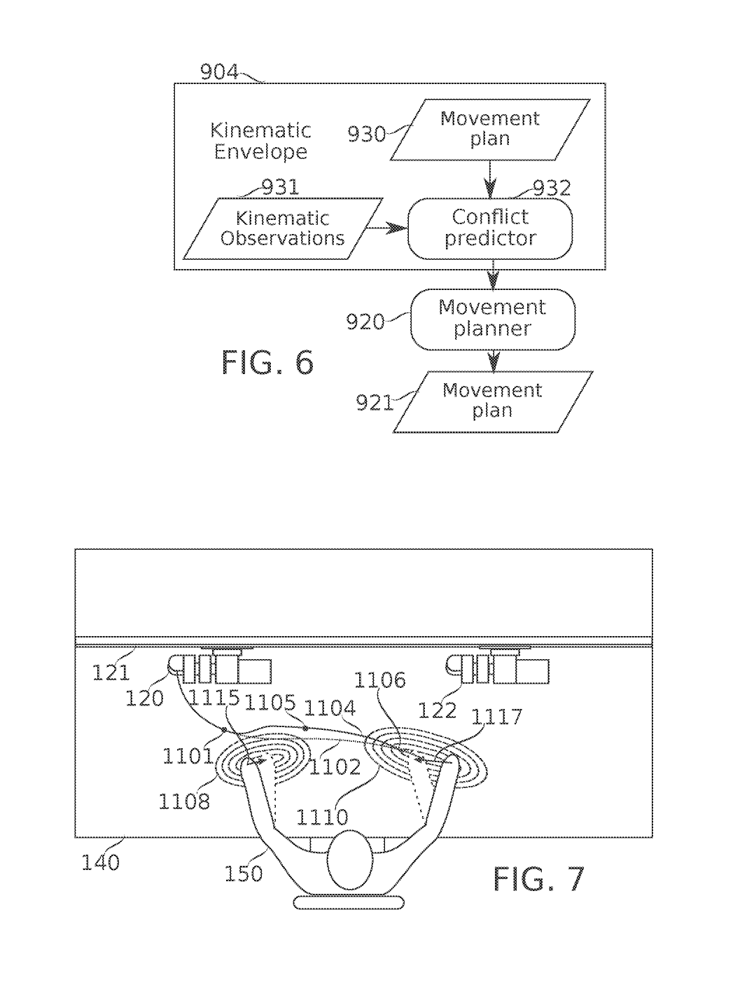

Reference is now made to FIG. 6, which is a schematic flowchart describing the generation and optional use for robotic activity control of a safety and/or targeting envelope predicted based on kinematic observations of the movement of a human operator 150, according to some embodiments of the present disclosure. Reference is also now made to FIG. 7, which schematically illustrates an example of a safety and/or targeting kinematic envelope generated and used according to the flowchart of FIG. 6, according to some embodiments of the present disclosure. FIG. 7 schematically represents zones of anticipated positions 1108, 1110 of body members of a human operator performing a task operation in collaboration with a robot 120. Robot 122, rail 121, and working surface of workbench 140 are also shown for reference.

Within block 904, in some embodiments, a kinematic envelope is generated by conflict predictor module 932. Conflict predictor 932, in some embodiments, is implemented as a module of control unit 160. In some embodiments, the inputs to conflict predictor module 932 comprise kinematic observations 931 of the human operator's 150 body members (comprising position measurements, for example measurements as described in relation to FIGS. 3A-3E, herein). Optionally, the inputs comprise an existing movement plan 930 (for example, a movement plan generated according to the procedure of FIG. 4). Additionally or alternatively to the use of an existing movement plan, there is provided and used in some embodiments an operation definition (not shown in FIG. 6); selected, for example, from operation definitions 913 as described in relation to FIG. 4.

Conflict predictor 932, in some embodiments, applies equations of motion to measurements of current human operator 150 body member position, velocity (recent change in position over time), and/or acceleration (recent change in velocity over time) to predict where each measured body member is expected to be over a brief future time period, e.g., a period during which a robotic part is in motion or performing another activity. The kinematic terms just mentioned are given as examples; optionally other (e.g., higher order) kinematic terms are used, for example: joint angle (optionally including terms describing how joint angle changes), change in acceleration and/or changing change in acceleration.

In some embodiments, to simple extrapolation from current state (e.g., the displacement arrows 1115, 1117 of FIG. 7 representing positions at some particular future time) is added a degree of future uncertainty. This can be embodied in different ways. For example, in some embodiments, future acceleration is assumed to potentially vary from the current value. The variation (and its results on body member position over time) is optionally simulated within a range based on the current acceleration (e.g., within ±10%, ±20%, ±30%, ±40%, ±100%, or within another range).

In some embodiments, previously observed associations between current kinematic measurements and future kinematic state are used to define a range of possible future positions. For example, for a body member (a hand, for example) may be associated by current measurements with a certain kinematic state vector (for example [P₀, V₀, A₀], comprising position, velocity, and acceleration). This current kinematic state vector is mapped e.g., by the conflict predictor 932, with measured past kinematic state vectors of body members (other hands, for example) moving similarly within a task cell 100. Any suitable definition of similarity may be used; for example, Euclidean vector distance within a threshold. Then, in some embodiments, the extrapolated future state of the currently moving body member is predicted as a superposition of the previously observed future states evolving from those similar kinematic state vectors.

In FIG. 7, the envelopes 1108, 1110 illustrate results of expanding current kinematic state to a range of possible future positions (at some moment in future time). The contours optionally delineate zones of different probability of occupation, or another weighting statistic.

In some embodiments, movement planner 920 uses envelopes 1108, 1110 to adjust robotic movements (and/or other robotic actions) to avoid (e.g. for safety) and or seek (e.g., for collaborative actions) the positions of body members of human operator 150, producing a new or adjusted movement plan 921.

For example, at point 1101, kinematic predictions by conflict predictor 932 show that continuation of robotic arm 120 along path 1102 is expected to intrude (and/or it cannot be sufficiently ruled out that path 1102 will not intrude) into the predicted kinematic envelope 1108 at some future time. Optionally, movement planner 920 diverts the motion of robotic arm 920 onto a new path 1106.

As an example of target adjusting, the originally planned motion of robot 120 targeted the end of path 1106, based on the then-expected final position of the right hand of operator 150. During the motion, the right hand begins to move in such a way that, at point 1105 along path 1106, it is now predicted that robot 120 has a likelihood of overshooting. Movement planner 920 compensates by producing a new and/or modified movement plan 921 along movement path 1104.

Action adjustments based on the kinematic envelope prediction do not necessarily seek absolute avoidance of any chance of collision, or perfect target seeking at each moment. For example, a threshold of collision likelihood is optionally set to trigger re-planning when a possibility of collision is about 1%, 5%, 10%, 20%, 25%, 50%, or another larger, smaller, or intermediate probability. As a collision likelihood. rises over time, the threshold may be exceeded. It is noted that kinematic envelope predictions are optionally recalculated continuously during robot activities at any suitable interval, for example, every 20 msec, 50 msec, 100 msec, 500 msec, 1000 msec, or another larger, smaller, or intermediate interval.

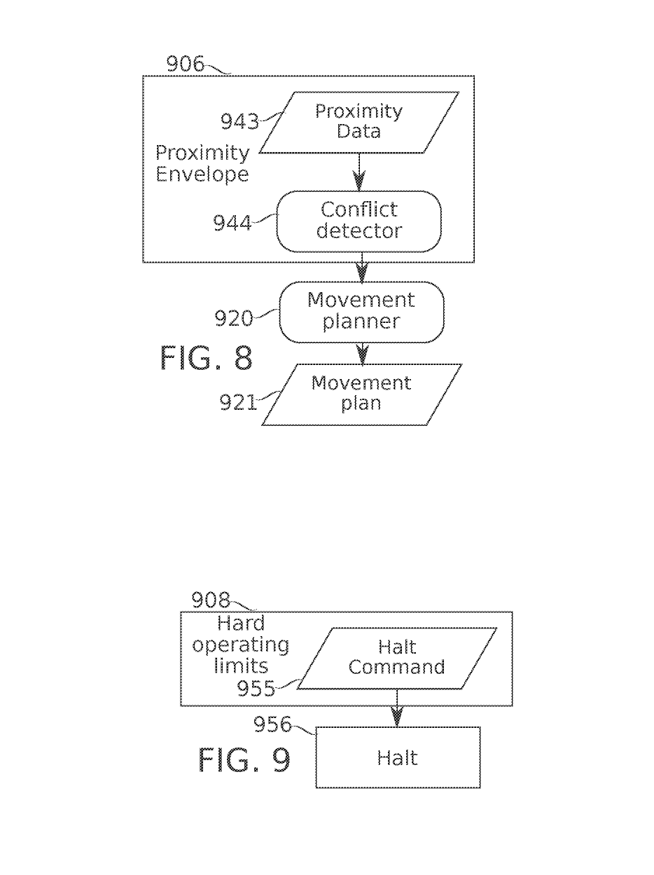

In some embodiments, a criterion of estimated reaction time need to respond to a potential collision is used in planning activity adjustments. For example, a possible collision optionally is only reacted to by the movement planner 920 when the situation reaches a point beyond which the robotic arm cannot be guaranteed to respond in time to an avoidance command (this also may be understood as a type of proximity envelope, as described in relation to FIG. 8). Optionally, movement planner 920 seeks to maintain a certain minimum avoidance buffer by making small adjustments (e.g., adjustments with no more than a small time penalty) to movement early so that sudden adjustments are less likely to be needed to avoid a collision later on. Optionally, any sufficiently low-penalty path adjustment is immediately implemented to reduce collision likelihood, but high-penalty path adjustments are avoided until the no-collision guarantee is at immediate risk. Optionally, instead of full collision avoidance being the goal of the movement planner 920, the goal is to avoid collisions at or above some velocity threshold which is deemed to be potentially dangerous, e.g., 5 cm/sec, 10 cm/sec, 20 cm/sec, 50 cm/sec, 100 cm/sec, or another faster, slower, or intermediate collision velocity. Optionally, the velocity threshold is set asymmetrically for movements by the robot and movements by the human operator; for example, a body member of the human operator is allowed to approach the robot at a relatively higher velocity when the robot is itself moving at a relatively slow velocity (e.g., human:robot relative velocities in a 2:1, 3:1, 5:1, 7:1, 10:1 ratio or higher).

### Proximity Envelopes and Halt Commands

Reference is now made to FIG. 8, which schematically illustrates an example of generation and use of a proximity envelope, according to some embodiments of the present disclosure.

In some embodiments, proximity envelope 906 is generated by conflict detector 944, based on inputs of proximity data 943. Conflict detector 944, in some embodiments, is implemented as a module of control unit 160. In some embodiments, proximity data 943 comprises motion capture position data, such as is used, in some embodiments, with envelopes 902 and/or 904. In this case, proximity envelope 906 is optionally implemented as essentially the limiting case of kinematic envelope 904. In some embodiments, other proximity data is provided as input. For example, a worn device such as one of those described in relation to FIGS. 3C-3E optionally comprises a radio transmitter and/or receiver (such as an RFID device). When a suitably equipped robotic part comes within range of the transmitter and/or receiver (e.g., close enough to elicit and receive a query response from the RFID device), proximity is detected, and evasive action taken. Optionally, the robot is provided with members that make (and sense or allow sensing of) soft contact before dangerous contact, e.g., protruding whiskers coupled to a force detector, soft sleeves with surfaces configured to capacitively sense contact, or another sensing device. According to the level of detail available from the proximity data, evasive action planned by movement planner 920 to produce a modified movement plan 921 can be, for example: to slow the robot, stop the robot, and/or to withdraw the robot. For example, if mere proximity is detected, movement planner 920 may be unable to determine what evasion direction is correct, so that slowing or halting the robot arm is the safest choice. If direction as well as proximity is detected (for example, it is known which side of the robot 120 a sensor whisker deploys on), withdrawal becomes an additional option for evasion in some embodiments.

Reference is now made to FIG. 9, which illustrates the detection and use of hard operating limits 908, according to some embodiments of the present disclosure.

In some embodiments, a halt command 955 is issued, resulting, at block 956 in a halt of robotic activity (e.g., halt of movement and/or halt of tool operation). Any of the optically or otherwise sensed conditions of envelopes 902, 904, 906 are optionally treated as halt commands 955; however, it is a potential advantage for halting behavior to be limited to collision is clearly imminent, otherwise unavoidable, and potentially dangerous. In some embodiments, additional types of inputs may also be accepted as halt commands. For example, sensed force displacement of the robot at one or more of its joints optional triggers robot halting (embodiments providing examples for this option are described in relation to FIG. 10A-10G). Optionally, there is provided, for example, an emergency stop button, and/or facility to respond to verbal commands such as “stop”, loud noises, heavy vibrations, or any other explicit or implicit indication of a need for a safety break in robot operation.

Example Displacement Force Sensing Mounting

Reference is now made to FIG. 10A, which schematically illustrates a robotic arm 120 mounted on a rotational displacement force sensing device 430, and also comprising an axis displacement sensing device 420, according to some embodiments of the present disclosure. These two devices are explained further in FIGS. 10B-10G.

Reference is now made to FIGS. 10B-10C, which schematically illustrate construction features of axis displacement force sensing device 420, according to some embodiments of the present disclosure. In some embodiments, device 420 comprises two plates 461A, 461B held separate from one another by springs 462. In FIG. 10B, the device is shown with the springs out of position in order to better reveal the normal relative positions of the two plates. In FIG. 1C, the springs 464 are shown in place, held to each plate by their respective spring mountings 462, 463. Between the two plates are positioned a plurality of distance sensors 465, which in some embodiments comprise optical sensors that measure the distance from the sensor to the plate surface opposite.

Reference is now made to FIGS. 10D-10E, which represent axis displacements of a robotic head incorporating the axis displacement force sensing device 420 of FIGS. 10A-10C, according to some embodiments of the present disclosure. Robot head 515 is mounted to device 420 on an axis passing therethrough, and configured to rotate in directions indicated by arrow 452 in FIG. 10D.

When lateral force (for example, due to a collision with body member of a human operator) is directed to a load carried on plate 461A (for example, robot head 515), plate 461A tends to tilt on its springs 464 (arrow 451), changing the distance sensed by one or more of the sensors 465. Control unit 160, in some embodiments, receives the changing sensor output. In some embodiments, when the distance change exceeds some threshold value, control unit 160 interprets this as a halt command, for example as described in relation to FIG. 9. In some embodiments, the distance change is continuously monitored, allowing graded response (for example, lowering of motor operation power) to be implemented before a full halt is brought about. Optionally, halting and/or slowing responses are curtailed or adjusted to account for changes under expected loads, for example, when tool head 515 is being pressed up against a workpiece in order to accomplish an operation action.

Reference is now made to FIGS. 10F-10G, which schematically illustrate normal and displaced positions of a portion of the rotational displacement force sensing device 430 of FIG. 10A, according to some embodiments of the present disclosure.

In some embodiments, parts of a robot 120 are mounted to a rotational sensing device 430 at any suitable rotating articulation point, for example as shown in FIG. 10A. FIGS. 10F-10G show device 430 from a face-on view. In some embodiments, elements 433 and 434 (outer element 434 may be a housing for inner element 433) are pressed up against one another to form a friction fit that resists rotation up to a certain force. They are optionally provided with surface protrusions such as ratchet teeth to enhance the friction fit. Additionally or alternatively, inner element 433 is held in place with respect to outer element 434 by an elastic arrangement; for example, springs (not shown) that interconnect them. Normally, element 434 rotates together with element 433 upon the exertion of rotational force on element 433. However, upon a sufficient torquing force 432 being generated against the element 434, element 434 escapes locking with element 433, causing rotational displacement, for example, as shown in FIG. 10G. The displacement is optionally sensed in any suitable fashion, for example, using an optical encoder, a potentiometer change, or another sensing device. Control unit 160 is optionally configured to react to a sensed change in the alignment of elements 433 and 434, for example, by shutting down operation of the robot, or in another way, for example as described in relation to axial displacement force sensing device 420.

Task Configuration and Validation

General Performance of a Task

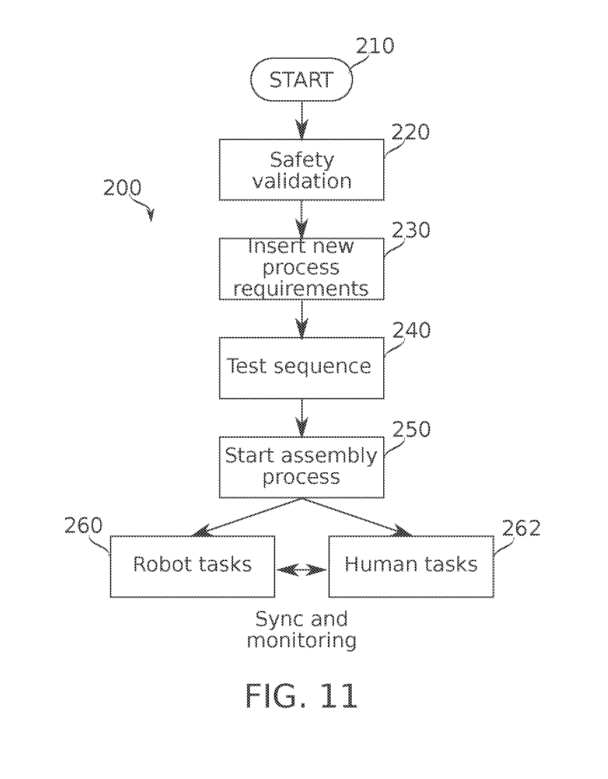

Reference is now made to FIG. 11, which is a flowchart 200 schematically illustrating a method of configuring and using a robotic task cell, according to some embodiments of the present disclosure.

The flowchart of FIG. 11 assumes the prior configuration of the task cell and of one or more task plans describing a task (process) for use with the task cell. The flowchart starts (block 210) with the selection of a new task plan (such as a plan for an assembly process) by a human operator or by a per-set set of orders in a software or firmware. In some embodiments, the task plan is implemented as detailed further with respect to FIGS. 12-14.

At block 220, the task cell is subjected to safety validation, for example by executing operations that should trigger safety systems.

At block 230, in some embodiments, the actual new task is activated by the human operator, and/or by pre-set information.

At block 240, in some embodiments, the sequence of operations needed to perform the task is tested (stepped though in an actual or simulated run), to validate the robot's functionality as well as the human operator's 150 understanding of the process.

At block 250, the task process begins.

At that point, robot tasks 260 and human tasks 262 proceed, being performed in parallel independently or in collaboration, for example as described in relation to FIG. 2A, optionally including synchronization and monitoring to keep both sides working in coordination.

Operation Planning/Training

Reference is now made to FIG. 12, which schematically illustrates a flowchart for designing a new collaborative task operation to be performed with a task cell 100, according to some embodiments of the present disclosure. The flowchart is described as if being performed with respect to a physical task cell. However, it should be understood that a simulated task cell can also be used in training, so long as it is set up with appropriate simulated parts corresponding to those which will be found in actual task cells when the task is performed. Optionally, design and/or modification of a collaborative task operation occurs as part of ordinary performance of the task, for example, based on actually recorded actions.

The flowchart of FIG. 12 is provided for purposes of explanation to provide a usable example of how the procedure of configuring a task operation could be accomplished, and does not exclude the substitution of other methods of configuring a task operation, including modifications of the current task in which steps unneeded for a particular task are omitted, duplicated, or otherwise changed as necessary.

The flowchart begins, and at block 1202, in some embodiments, layout of task cell 100 is performed. This can include mounting robots 120, calibrating the robots in their positions, positioning parts and tools, and otherwise preparing the working environment with needed elements in their appropriate positions. Examples of items placed in the working environment of task cell 100, may include, for example, material handling devices such as jigs part feeders and/or fixtures; holding devices such as tabletop- and/or rack-mounted location pins configured to hold parts in reproducible positions and/or orientation; and/or tool racks and/or tool magazines. Tools used optionally comprise, for example, screwdrivers (and/or other tools used in fastening such as socket drivers and/or riveters), grinders (and/or other tools used in light machining such as grinding, filing, and/or finishing), soldering devices, cutters (laser, water, and/or mechanical cutters such as shears and/or saws, for example), and/or blowers (e.g., air blowers for heating and/or cooling). Optionally, specialized tools (for example, tools for performing actions specific to preparing cable connectors) are provided.

At block 1204, in some embodiments, an indication by the human trainer that a new operation is to be “taught” to the system is given. The indication can be any appropriate button press, user interface command, gesture, verbal command, or other indication that the system is configured to receive and interpret.

At block 1206, in some embodiments, a robot is brought into a position at which some further operation is to be performed. Optionally, the position is an absolute position. However, the position can also be defined conditionally or otherwise partially abstracted; for example as “the first available component”, “the first available empty space in a certain tray”, “a position just in front of the right hand”, and/or “a position corresponding to a certain marker”. The positioning (and/or any other action of the operation) is optionally performed as the robot carries out an already defined operation which is to be modified in the current training session.

At block 1208, in some embodiments, a suboperation to be performed at the position set in block 1206 is selected. The suboperation may comprise, for example, operation of a tool, grasping of a tool or component, or another suboperation.

At block 1210, in some embodiments, triggers, targets and/or halting conditions which may apply to the current part of the operation are defined. Some of these, particularly halting conditions, may he safety-related, for example, sensitivity to proximity and/or over-force. Optionally, default halting conditions are intentionally disabled, or otherwise tuned, for example in order to allow an operator to manually interact with the robot and/or to let the robot ignore normal contact forces exerted through a tool. In some embodiments, triggers indicate the beginning and/or end of a suboperation: for example, if torque sensed through a screwdriver tool exceeds a threshold, the screw that it drives may be considered to have been completely inserted. Targets for suboperations are optionally indicated as fully predetermined (e.g., a particular tool), predetermined with some variable conditions (e.g., the next item in a tray), or dynamically determined, for example according to spoken, gestural, and/or other control indications given by the human operator.

In explanation of the meaning of a “suboperation”, reference is now made to FIG. 13, which is a flowchart schematically indicating phases of a typical defined robotic suboperation, according to some embodiments of the present disclosure.

The result of blocks 1206-1210 together is considered to define an example of a “suboperation”, one or more of which may be strung together to complete an overall operation. Operations in turn may be strung together to create tasks. The divisions among levels are chosen for the sake of convenience; there is, for example, not necessarily an absolute dividing line between what is a suboperation and what is an operation. For purposes of description herein, a “suboperation” is a use of low-level robotic facilities. It comprises a simple pairing of movement and actuation (optionally only one of these), optionally together with the events, prerequisites, and/or conditions that trigger it, and a state (e.g., waiting for the next event) that exists after it is complete.

An “operation” encapsulates suboperations. It could simply be one suboperation, but often comprises a stereotyped sequence of one or more sub-operations producing an intermediate result, and after which the next operation may or may not be determinately selected. There may be suboperations by a plurality of agents within an operation, for example, one or more robots, and/or a human operator. An operation is treated herein as a goal-oriented, functional building block of larger assembly and/or inspection tasks. At the same time, some operations are sufficiently general that they can be used as “plug in” objects for a range of different tasks.

In some embodiments, an operation also defines an “indication context”, which sets how verbal commands, gestures and other inputs from the human operator are interpreted. For example, if the operator says “bring the screw”, the command term may be ambiguous in the context of the task overall if there is more than one screw type. Within the context of a certain operation, however, it may be clear, once the operation has begun, which screw type is necessary at the current part of the operation. In some embodiments, different indication contexts are set for different operations. In some embodiments, an indication context defines the available palette of “nouns” (thinks to be acted upon/with) and “verbs” (actions performable) that can be commanded, restricting them to reasonable alternatives for the current operation.

To give a set of examples: “operating a screwdriver” is a suboperation (or optionally part of a suboperation that also comprises “moving a screwdriver into position”); “screwing two parts together” is an operation (parts, screw, and tool all need to be moved into position as separate suboperations before the screwdriver can be operated), and “assembling an assembly comprising two parts and two screws” is a task (in accordance, for example, with the main example of FIGS. 17A-17D).

At block 1302, the suboperation begins with whatever triggers have been set for it (which may be, for example, the end of the last operation, an indication by a human operator 150, a timer event, completion of an operation by a different robot, or another event). At block 1304, in some embodiments, the robot optionally moves into position, according to its training for the current operation. At block 1306, in some embodiments, an action is optionally performed at the position to which the robot has been moved, for example, activation of a tool, and/or grabbing or releasing a part or tool. Suboperations optionally comprise actions 1306 without translational movement 1304 (for example, if more than one action is to be performed in the same location), or movement 1304 without action (for example, if the movement is performed in order to move the robotic arm out of the way until it is next needed).

At block 1308, in some embodiments, the robot optionally triggers its next suboperation (or a new operation entirely), and/or moves into a wait state to receive the next suboperation or operation trigger.

Returning to the flowchart of FIG. 12: in some embodiments, a decision is made at block 1212 whether or not to add more suboperations to the current operation. If yes, flow returns to block 1206.

Otherwise, flow continues at block 1214, where the operation definition is optionally completed with the assignment of triggers, prerequisites, halting conditions, and/or target designations to the “package” of suboperations it encapsulates. On top of the sorts of environmental assignments discussed with respect to suboperations at block 1210, the operation can be defined to designate an “indication environment” that gives localized meaning to certain general indications, for example as explained in relation to FIG. 13.

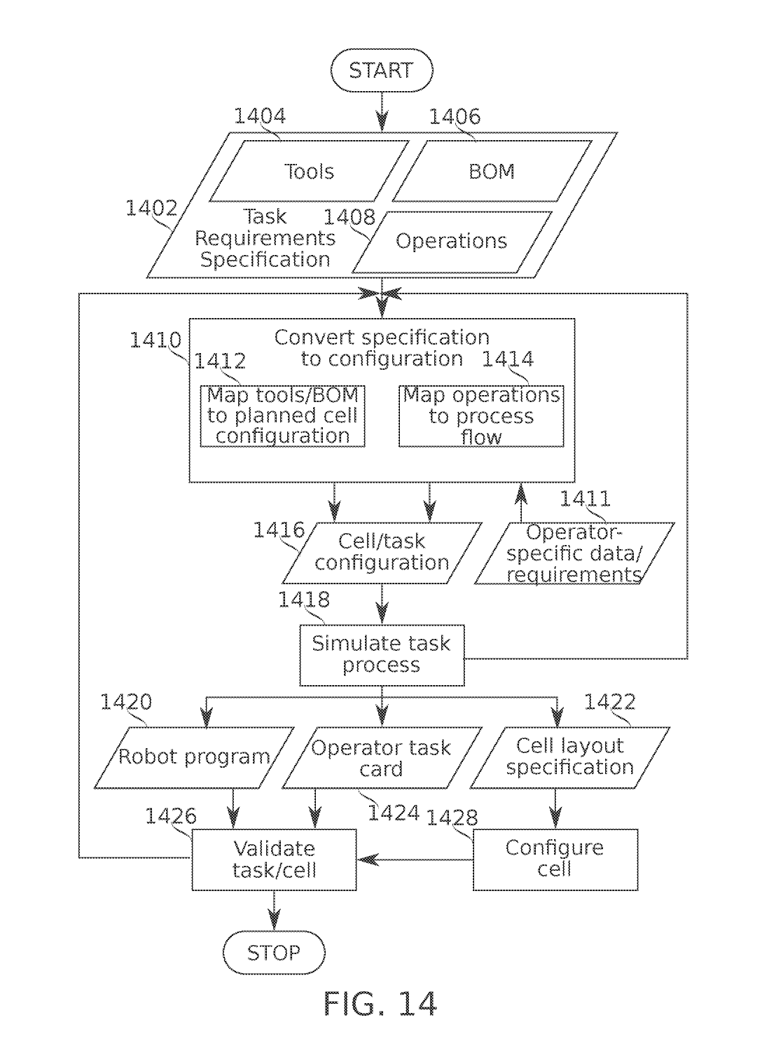

At block 1216, a decision is made as to whether or not more operations should be defined. If so, flow returns to block 1204. It is noted that operations need not be actually taught in their assembly order; optionally, they are connected in larger flow charts, for example as described in relation to FIG. 14 and FIGS. 17A-17D herein.

Otherwise, at block 1218, in some embodiments, testing and adjusting of the trained operations is performed as necessary, and the flowchart ends.

### Task Planning/Training

Reference is now made to FIG. 14, which schematically illustrates a flowchart for the definition and optionally validation of a task (for example, an assembly and/or inspection task) for use with a task cell 100, according to some embodiments of the present disclosure.

In some embodiments, a task is defined based on a task requirements specification 1402 is provided. In some embodiments, the task requirements specification comprises a list of tools 1404, a bill of materials 1406 (BOM), and a set of operations 1408 that need to be performed in the task cell, and using the tools 1404 and BOM 1406 in order to complete the task. For purposes of this description, the operations are specified as “high level” descriptions at this point—specifying what needs to connect to what, for example, without necessarily specifying in detail how this is to be done.

In some embodiments, operator-specific data/requirements 1411 are optionally provided for one or more operators. The operator-specific data/requirements 1411 optionally include past-performance information for operations of types specified in the task requirements specification, for example, recorded body member motion data, and/or summary statistics such as throughput rates and/or fatigue statistics. In some embodiments, the operator-specific data/requirements include mention of specific preferences, characteristics, and/or incapacities; for example, handedness, disabilities (e.g., an operator is working one-handed), size of the operator (weight, height, and/or limb length, for example), whether an operator works best close to their body (e.g., due to eyesight or limb length) or prefers a larger spacing, preferred (and/or previously used) rates of robotic motion, and/or other characteristics. In some embodiments, operator-specific data is assigned by type, each type comprising one or more operators. In some embodiments,

At block 1410, in some embodiments, the task specification is converted into a usable task configuration for a task cell. In some embodiments, the task requirements specification is loaded into a software tool comprising a CAD tool implementing modules usable by, for example, a production and/or manufacturing engineer to map the task requirements specification 1402 to the specifics of the task cell 100 and optionally its environment. The CAD tool may, for example, provide spatial and kinematic modeling of the task cell 100 and optionally its environment and/or the human operator 150.

At block 1412, in some embodiments, items on the tool list 1404 and BOM 1406 are mapped into a planned task cell 100 configuration, for example by creating representations of these items in the CAD tool simulation and placing them appropriately in a simulated task cell 100.

At block 1414, in some embodiments, the operations 1408 are mapped into the process flow of the task. This itself optionally comprises three main parts: operation selection, operation linkage into an overall task flow, and control setup.

For the first part, in some embodiments, operations are selected from a library of pre-existing operations which fit (possibly after suitable modification for specific targets such as tools, BOM items, and their locations in the planned cell configuration) the requirements of the current operations list 1408. Optionally, one or more new operations is designed, for example as described in relation to FIG. 12, herein. Optionally, the library also includes one or more predefined sequences of operations.

For the second part, in some embodiments, operations are linked together into an overall task flow. A task flow may be conceptualized as a flowchart which shows how each operation which may be used in completing a task is related to other such operations with respect to following, preceding, and optionally running in parallel with them. There may be only one (e.g., a predefined sequence) or a plurality of paths through a task. Optionally, there are defined a plurality of different paths that each individual operation can be a part of. Operations may run in parallel to one another (that is, simultaneously), for example in parts of the task where robotic activities and human activities can proceed separately from one another.

In some embodiments, the task flow environment is substantially or fully free-form within the available set of operations, or switchable between a defined task flow and a free-form task mode. This is of potential use, for example, to allow the operator to use the workbench in a “problem solving” mode. This potentially reduces overhead of task setup and design, but may decrease accuracy and/or efficiency. For example, free-form task design may make the robotic system unable to correctly anticipate the next operation (potentially reducing movement planning efficiency), potentially less able to operate autonomously when appropriate, potentially more error prone in interpreting user indications, and/or may reduce the possibility of confidently validating an overall assembly task.

Individual operations are preferably modular in definition, allowing them to be strung together without requiring internal modification based on what has gone before or is expected after. However, operations will, in some embodiments, include prerequisites which can entail inter-operation reconfiguration such as switching tools, and/or retrieving and/or putting away parts and assemblies. There may also be inputs specified as “variables” in an operation; for example, the designation of a particular part portion as a target for an operation. The prerequisites may be different for different paths: along some task paths, a part may be ready to work on immediately, while along others, the part may need to be retrieved. The process of task definition, in wine embodiments, provides the procedural “glue” that allows the modular operations to be used flexibly in this fashion. The example of FIGS. 17A-17D shows this in further detail.

The third part, in some embodiments, is control setup. As explained with respect to FIG. 2A, it is a potential advantage to allow human operator control modalities over a robotic collaborator which avoid placing a heavy attentional load on the human operator.

In some embodiments, these control modalities include vocal commands and/or gestures (e.g., movements of the head, hands, and/or arms).

Control modalities, in some embodiments, combine speech and or movements (gestures) of the operator. Brief speech utterances can be ambiguous, particularly in the context of assembly tasks where there may be far more possible targets for an action than can be easily distinguished by name. For example, it would potentially be tedious and/or error prone for an operator to have to give the circuit board or BOM designation of each component that might need robotic soldering assistance. In many assembly operations, there may not even be pre-existing designations at the resolution required (for example, subregions of parts). Adding selection indicating gestures such as pointing to spoken commands potentially helps to overcome this problem. Other selection indicating gestures besides pointing optionally include, for example, bracketing a region between two finger tips, framing a region by placement of one or more fingers, running a finger over a region, and/or holding a part of a piece up to a particular part of the workbench environment or robot that itself serves as a pointer, bracket, frame, or other indicator. Examples of commands combined with an indicating gesture in some embodiments include: “hold that”, “solder here”, “show enlarged on screen”, “report inventory of this part”, “display characteristics of part”, “check soldering quality of part”, “drill here”, “screw here”, “bring the compatible part”, and/or “pause assembly execution protocol”. Optionally, (for example to avoid inadvertent control signaling), a gating command such as a foot pedal press, activating word, and/or activating gesture is used to indicate that the human operator is giving a deliberate command. Optionally, the activating gesture is a hand, arm, and/or head gesture unlikely to occur incidentally, such as a specific hand shape, sequence of arm movements, distinctive facial movement (squint, blink, jaw movement, for example), and/or some combination thereof.

In some embodiments, operation-defined indication context (for example, a pre-set list of relevant command indications) potentially helps to simplify the problem of control by reducing the number of things which a control indication by an operator could mean in the current context. For a screwing operation, for example, it is optionally made clear by operation context that a pointing gesture refers to the nearest screw hole shape in particular. In another example, depending on the current task and operation context, a gesture moving in the direction of a part tray could alternatively mean, for instance: (1) bring a part from the indicated tray, (2) put a part in the indicated tray, (3) pick up a part from the indicated tray and do nothing with it yet, or (4) nothing. By breaking down a task's command environment into ordered operations in which only one of those meanings might be relevant, the ambiguity could be resolved or reduced. In some embodiments, gestures accepted as commands are selected to be one or both of: easily generated by the human (for example, broad directions of movement); and easily distinguished by a motion tracking system both from each other, and from normal task-oriented, but non-indicating body member movements.

It is also noted that some task-oriented movements are optionally also implicitly indicating movements, which can be taken advantage of in defining appropriate control indications for operations. For example a human movement toward a robot manipulator to assist in an assembly step which is usually fully automatic might indicate that something has gone wrong, and that the robot should stop and wait for correction.

In another aspect: while the technology of text-to-speech conversion is becoming increasingly accurate, the risk of misunderstanding in a potentially noisy, potentially dangerous manufacturing setting is reduced further, in some embodiments, by restricting voice commands available in any given operation context to those which are potentially relevant not just domain specific, but optionally specific down to the context of the current operation. Optionally, speech commands which are allowed are selected to be distinct from one another in sound, to further reduce the likelihood of confusion. Optionally, speech sensing is configured to reject sounds coming from positions other than that of the operator's head; for example by using directional microphones. Optionally, different delays among sounds received at different microphones are compared to ensure that they are consistent with sounds produced at the presumed or known (optionally, motion-tracked) position of the operator's head.

In some embodiments, the results of blocks 1412 and 1414 produce cell/task configuration 1416, which at this point in the flowchart remains a configuration applicable to a simulation of a task cell. Optionally, more than one version cell/task configuration 1416 is produced. Different versions are optionally produced for testing purposes; for example, in order to see which version is preferable when reduced to practice.

In some embodiments, different versions are provided for users of different capacities, strengths, weaknesses, and/or preferences, for example as defined by operator-specific requirements 1411. Optionally, one or more initial versions of the configuration are explicitly customized to different human operators and/or classes of human operators, for example, left handed/right handed operators, new operators/experienced operators, fresh operators/fatigued operators, and/or operators who are found to be better at (and/or or worse at) some operations of the task than others. In some embodiments, task flow for the aggregate of individual operators on a production floor is balanced by customization of individual task process flows. For example, if there are two operators, one who is known to be faster at inspection tasks, the one who is faster at inspection may receive a task configuration which occasionally duplicates inspection (of the other operator's assemblies), while the second operator occasionally skips inspection (passing the assembly on to the first operator). Potentially this helps to optimize total operator time spent on each type of operation.

At block 1418, in some embodiments, the task process is simulated, still using the CAD tool, to verify that it performs as expected. There may be additional cycles of mapping and simulation (e.g., returning to block 1410 and adjusting the configuration settings) before an acceptable cell/task configuration 1416 is validated by simulation. At that point, there are, in some embodiments, three main outputs which reach the production floor: the robot program 1420, which will govern robot behavior, the operator task card 1424 which tells the operator what to do (optionally task card 1424 is not a literal card, but rather any instructions suitable for presentation to a human operator, for example on screen 161), and a cell layout specification 1422.

In some embodiments, instructions for the user are presented as text, image, video, and/or auditory information. For example, video instructions are optionally presented as live recordings of the operation, and/or as animations derived from simulations, e.g., as generated in block 1418. Optionally, a human operator can select a level of detail at which instructions are presented. Optionally, instructions for an operation include detailed indications of best-practice movements to be performed. Optionally, instructions comprise text explanations of parts and tools used, motions performed, and/or the intended outcome of the operation. In some embodiments, is variations of actual operator performance from instructed and/or best practice performance is determined, based on motion-recorded differences and/or robotic motion difference from a baseline. In some embodiments, human operators (and/or managers and/or engineers) are shown the differences in real time (e.g., on screen 161), encouraging correction. In some embodiments, the system gives feedback to operators, managers, and/or engineers which indicate trends in recorded task data, such as robotic movement safety data (incidents and/or near incidents), predictive targeting effectiveness, and/or speeds of actions, operations and/or tasks overall. In some embodiments, speeds of actions are about 100 msec, 500 msec, 1 sec, 2 see, 5 sec, 10 sec, 20 sec, or a longer shorter or intermediate time. In some embodiments, times of operations are about 100 msec, 500 msec, 1 sec, 2 sec, 5 sec, 10 sec, 20 sec, 30 sec, 60 sec, 5 minutes, or a longer shorter or intermediate time. In some embodiments, a task overall takes about 5 sec, 10 sec, 20 sec, 60 sec, 2 minutes, 5 minutes, 10 minutes, 15 minutes, or another longer shorter or intermediate time. Optionally, these data are used to guide refinement of the task configuration, and/or to guide decision making on assignments, training and/or retraining of human operators.

At block 1428, a testing cell is configured according to the cell layout specification 1422. At block 1426, the task is performed in the actual task cell 100, according to the robot program 1420 and the operator task card 142. If all works as expected, the flowchart ends. Otherwise, there is optionally a return to an earlier stage (e.g., block 1410) in order to work out the problems.

Optionally, a task configuration 1416 is subject to further adjustments during a potentially extended period of its use. There may be a planned period of experimentation and optimization during which a task configuration 1416 is tuned for such issues as bottlenecks, fatigue, and/or movement optimizations. In some embodiments, human operator experience with the task in normal production suggests changes. Optionally, one or more “best practice” operation sequences are developed, and the task adjusted to require and/or encourage these sequences. There are individualized adjustments made in some embodiments, e.g., to accommodate different human operator capabilities and/or working styles.

Quick-Release Robot Mounting

Reference is now made to FIGS. 15A-15B, which schematically illustrate views of a quick-connect mounting assembly 700 for connecting a robotic arm 120 to a mounting rail 121, according to some embodiments of the present disclosure.

In some embodiments, at least one robotic arm 120 (representative in this case of any robotic arm) is mounted for operation with task cell 100 on a rail 121. In some embodiments, attachment of the rail mounting 700 to rail 121 comprises tightening of rail mounting knobs 710. In some embodiments, rail mounting knobs 710 are hand-tightenable and -releasable; e.g., by screwing or unscrewing. In some embodiments, rail mounting knobs 710 are spring loaded so that they can snap into place for initial mounting, and/or be pulled out of position after unscrewing to release mounting assembly 700 from mounting rail 121.

A potential advantage of hand-tightenable and -releasable rail mounting knobs 710 is to allow quick swapping of robotic arms 120 into new positions with respect to task cell 100 (e.g., in preparation for performance of a new task), and/or to allow ready swapping of arms between a plurality of task cell 100 stations, according to need.

In some embodiments, calibration of a robotic arm 120 after re-mounting comprises imaging the arm (e.g., using imaging devices 110), and correcting for differences in imaged position vs. targeted positions.

Optionally, a robotic arm 120 receives power and/or data connections directly from its mounting rail 121, further reducing complexity of transfer.

Another feature of robot 120, in some embodiments, is wireless control. This potentially reduces the need to run data cabling to connect between a control unit 160 and a robot 120 which is moved to a new unit cell. Instead, a wireless pairing procedure can be performed. Optionally, control unit 160 does not even need to be local to the task cell 100; it can be provided at a remote location and linked via a network protocol to the robot 120 it controls.

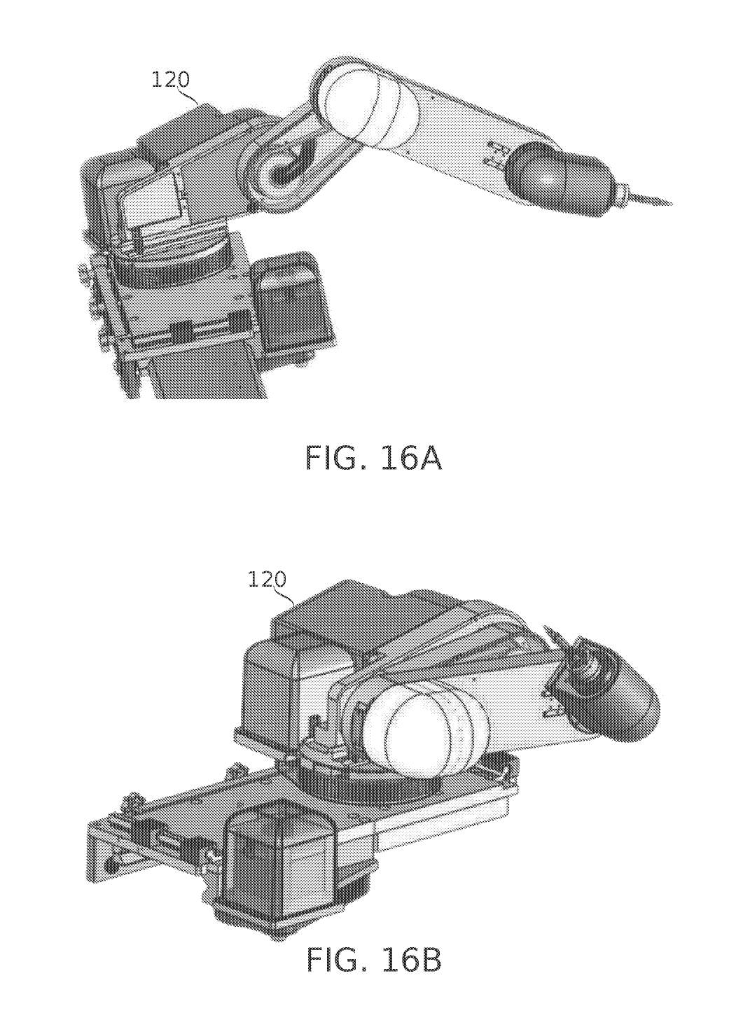

Reference is now made to FIGS. 16A-16B, which schematically illustrate, respectively, deployed and stowed (folded) positions of a robotic arm 120, according to some embodiments of the present disclosure. The stowed position of FIG. 16B is optionally assumed by the robot arm 120 at the end of a period of activity, and/or, for example, to allow easier handling of the robot arm 120; for example, to move the robot arm 120 among a plurality of task cells 100.

Collaborative Human-Robot Assembly and/or Inspection Tasks

Reference is now made to FIG. 17A, which is a simplified sample bill of materials (BOM) for an assembly task, according to some embodiments of the present disclosure. Reference is also made to FIG. 17B, which shows a flowchart of an assembly task, according to some embodiments of the present disclosure. Reference is also made to FIG. 17C, which shows a task cell layout for an assembly task, according to some embodiments of the present disclosure. Further reference is made to FIG. 17D, which describes operations of two robot arms 120 122 and a human 150 during an assembly task, according to some embodiments of the present disclosure.

The task illustrated in its different aspects by FIGS. 17A-17D is for assembly of a shell sub-assembly comprising two parts (Part 1, Part 2 in the BOM of FIG. 17A) which are optionally halves of the shell, and two screws (Screw 3, Screw 4 in the BOM of FIG. 17A) which secure the two halves of the shell together. The task itself is provided as an example to support descriptions of dynamic human-robot collaborative task flow.

In the example shown, assembly operations A-D (blocks 810, 812, 814, and 816) are performed by combinations of the human operator 150 and robotic arms 120, 122. FIG. 17D consists of a table describing roles (sub-operations) of each of these in operations A-D (e.g., Mode A refers to operation A of block 810). Robotic arm 120 is used for tool operations, while robotic arm 122 is used for part picking, storing, and/or manipulation. The human operator 150 performs tasks which are optionally difficult or unsuited for the robotic arms alone, such as fitting shell parts together, part inspection, and making decisions about task flow. The various paths between blocks 810, 812, 814, and 816 of FIG. 17B are marked with labels A′, A″, B′, C′, C″, D′, D″, D′″. For each path is separately defined (in the table of FIG. 17D) sub-operations which relate to preparation for the next assembly operation. FIG. 17C shows an example of how a task cell could be configured for performing the assembly task, including robots 120, 122 (mounted to rail 121, for example as shown in FIG. 1), human operator 150, tool set 826, connector supply 825 (for Screw 3 and Screw 4) and assembly trays or other material handing and/or storage devices 821, 822, 823, and 824, which optionally are used to hold Part 1, Part 2, and assemblies of those parts in different stages of completion. The items shown in FIG. 17C are provided as examples; items placed in the task environment may include, for example, material handling devices such as jigs and/or part feeders; holding devices such as tabletop- and/or rack-mounted location pins configured to hold parts in reproducible positions and/or orientation; and/or tool racks and/or tool magazines. The assembly example is described in more detail below.

In some embodiments of the present invention, human-robot collaboration provides a potential advantage over the use of either humans alone or robots alone by combining standalone advantages of each. For example, robots are well-suited to the performing of precise, repetitive operations at relatively low incremental expense. Humans are able to supply judgment, flexibility, and some perceptual capabilities that robots continue to lack, and/or are inconvenient and/or expensive to implement for coverage of all special cases. In some cases (for example, “small batch” manufacturing), configuring and validating a purely robotic assembly sequence may be cost prohibitive. On the other hand, human-intensive tasks are potentially expensive due to the relatively high incremental costs of labor. Breaking tasks into parts that can be performed purely by humans or purely by robots potentially is impractical in many situations, particularly when the strengths of each are needed in constant alternation.

In some embodiments of the present invention, tasks are defined to be divided between human and robot actors working in a shared environment. Potentially, this increases the efficiency of human labor by offloading, for example, repetitive and/or stereotyped operations to robotic assistance. At the same time, in some embodiments, the continuous availability of human judgment during a task potentially reduces planning effort that would otherwise be needed to make purely robotic operations substantially fail-proof. By making the environment collaborative, time and effort overhead associated with switching between human and robotic actors is potentially reduced.

In some embodiments of the invention, robotic assistance for a human operator 150 is provided with a library of relatively common and/or simple operations, which can be selected from and structured to occur within the context of a more complicated task. From one perspective, the human operator 150 provides the “glue” connecting the operations of a task into a coherent whole: snaking decisions, detecting failures, and/or filling in gaps where there is no appropriate robotic operation available. From another perspective, the robot or robots help to reduce the amount of time wasted on moving the assembly process along to reach the next situation where human capabilities are really needed. Optionally, human and robot work in parallel, for example, on non-interacting operations, as equivalent alternatives for some operations, and/or to allow simultaneous performance of operations which a single actor (robotic or human) would otherwise perform serially. In some embodiments, the robotic assistance effectively provides an additional “hand”; e.g., allowing an operation to rely on three or more simultaneous manipulations (first part, second part, and connector, for example) to perform a step that two hands or one robotic arm might find more awkward to complete.

The example of FIGS. 17A-17D illustrates several of these points, and will now be described in detail with particular reference to the flowchart of FIG. 17B, and the accompanying table of FIG. 17D.

In some embodiments, the assembly task starts with a suitable indication (such as a voice command or menu selection; other types of indications are described, for example, in relation to block 1414 of FIG. 14, herein) from the human operator 150 (“Start” in FIG. 17D). Optionally, the tool arm 120 prepares itself by selecting a screwdriver tool. The picker arm 122 (also referred to more formally herein as a material handling arm) may prepare itself by identifying and grasping an instance of Part 1 from a tray of such parts (e.g., tray 822).

At block 810, in some embodiments (operation mode A in FIG. 17D)), the picker arm 122 presents Part 1 to the human operator 150, who receives and inspects it for burrs.

In this example, Part 1 is a part which may be initially formed with extra material on it, for example, irregularities (referred to as “bun”) after a tooling process such as cutting or drilling. The material is removed by “deburring” by one of several possible processes such as grinding. Another type of extra material that can be present is “flash”, (removal of which is called deflashing). Flash may be due, e.g., to material leakage through a parting line of a mold during a molding or casting operation.

Recognizing such material is relatively easy for a human operator 150, but recognition can be a difficult to implement using automated tools such as machine vision. For example, burr material may appear at irregular positions, only on some examples of the part, and/or may be present with a relatively low optical contrast (e.g., since it's made of the same material as the part itself) so that it is difficult to automatically segment it with machine vision techniques. On the other hand, automatic grinding is an attractive method of removing a burr, since it can be potentially be performed precisely and rapidly on an identified target. Accordingly, deburring is an example of an operation where human/robot cooperation can potentially yield more efficient results than either actor working alone.

In some embodiments of the invention, task flow (that is, when to proceed to the next operation of the task, and optionally which of a plurality of operations to proceed to) is under the control of the human operator 150. In the task of FIGS. 17A-17D, the human operator 150, after inspecting at block 810 is able to indicate either that the next operation is to deburr (operation B of block 812) or to perform assembly (operation C of block 814). The indication provided by the operator optionally takes one or more of several different forms, for example:
A selection (e.g., via touch screen or mouse input) from a preset list of commands (e.g., displayed on display 161);
Gestures or other movements (e.g., as detected by imaging devices 110) of human operator 150;
Voice commands; and/or
Another input device controlled by the human operator 150, for example a foot pedal.

In some embodiments, the indication comprises an explicit instruction to the system. In some embodiments, the indication simply conveys an instruction to proceed with the next step of the task; e.g. pressing and/or releasing a foot pedal, button, or other switch-like input. In some embodiments, the indication is a selection from among presented options: e.g., by different switch presses tied to screen indication, or screen button selection presses. In some embodiments, a voice and/or typed command is used. Since the hands of operator 150 will often be busy with the task, non-hand input such as foot-operated or voice-activated commands is preferred in some embodiments.

Continuing with the flowchart: if the indication after completing operation A is to go to operation B (block 812) and deburr, the system performs the preparatory suboperations of A′ listed in the table of FIG. 17D. If, on the other hand, the indication after completing operation A is to go to operation C (block 814) and skip deburring, the system performs the preparatory suboperations of A″ listed in the table of FIG. 17D. At block 814, both of the robotic arms 120, 122 and the human operator participate in creating a partial Subassembly 1-3 by holding the two parts against each other while they are screwed together. Optionally, the human operator's indication includes an indication of which screw hole is to be used.

Operation D (block 816) is another screw-connection operation, using a second screw and screw-receiving part of Subassembly 1-3 to create final Subassembly 1-4.

The remaining details of the task relate to the different flow paths (marked by labels A′, A″, B′, C′, C″, D′, D″, D′″ in both FIG. 17B and FIG. 17D) linking operation blocks 810, 812, 814, and 816. A human operator 150 is able to choose between fully completing a Subassembly 1-4 in one sequence of operations, or first completing a plurality of Subassemblies 1-3, then cycling through those partial subassemblies to finish them into Subassemblies 1-4. The working strategy could vary during the course of a working session.

Reference is now made to FIG. 17E, which is a schematic flowchart that describes three different deburring strategies which could be adopted during an assembly task such as the assembly task of FIGS. 17A-17D (e.g., in conjunction with blocks 810 and 812).

At block 850, a part is displayed for burr inspection, and at 852 the human operation makes the burr inspection. At that point, the human indicates, in this example, which of three possible strategies to adopt for deburring. In the first strategy, at block 854, the human operator 150 marks a region for automatic deburring, for example using a marking device, or simply by indicating extents of the deburring target with a finger, stylus, or other indicating device. At block 856, the robot 120 then comes in and performs deburring automatically (e.g., with a grinder tool) across the region indicated in block 854. If the human operator indicates the second strategy at block 858 (for example, by actively reaching for the grinder tool-equipped robot), the robotic arm 120 optionally goes into a passive mode, where the human is allowed to pull the grinding tool into position and use it to perform the deburring required. In the third strategy, the human operator picks up a human-held grinding tool (which action itself is optionally treated by the task cell 100 as an implicit indication of the chosen operation) and performs deburring manually.

General

It is expected that during the life of a patent maturing from this application many relevant robotic types will be developed; the scope of the term robotic part or robotic member is intended to include all such new technologies a priori.

As used herein with reference to quantity or value, the term “about” means “within ±10% of”.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features except insofar as such features conflict.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A robotic system supporting simultaneous human-performed and robotic operations within a collaborative workspace, the robotic system comprising:
at least one robot, configured to perform at least one robotic operation comprising movement within the collaborative workspace under the control of a controller;
a station position, located to provide access to the collaborative workspace by human body members to perform at least one human-performed operation; and
a motion tracking system, comprising at least one imaging device aimed toward the collaborative workspace to individually track positions of human body members within the collaborative workspace;
wherein the controller is configured to direct motion of the at least one robot performing the at least one robotic operation, based on the individually tracked positions of body members performing the at least one human-performed operation.

2. The robotic system of claim 1, wherein the motion is directed according to one or more safety considerations.

3. The robotic system of any one of claims 1-2, wherein the motion is directed according to one or more considerations of human-collaborative operation.

4. The robotic system of claim 1, comprising a workbench; wherein the collaborative workspace is positioned over a working surface of the workbench accessible from the station, the station position is located along a side of the workbench, and the at least one robot is mounted to the workbench.

5. The robotic system of claim 4, wherein the workbench comprises a rail mounted horizontally above the working surface, and the at least one robot is mounted to the rail.

6. The robotic system of claim 1, wherein the individually tracked body members comprise two arms of a human operator.

7. The robotic system of claim 6, wherein at least two portions of each tracked arm are individually tracked.

8. The robotic system of any one of claims 6-7, wherein the individually tracked body members comprise a head of the human operator.

9. The robotic system of claim 1, wherein the motion tracking system tracks positions using markers worn on human body members.

10. The robotic system of claim 9, including the markers attached to human-wearable articles.

11. The robotic system of claim 4, wherein the at least one imaging device comprises a plurality of imaging devices mounted to the workbench and directed to image the workspace over the working surface.

12. The robotic system of claim 1, wherein the motion tracking system is configured to track human body member positions in three dimensions.

13. The robotic system of claim 1, wherein the controller is configured to direct the motion of the at least one robot to avoid a position of at least one tracked human body member.

14. The robotic system of claim 1, wherein the controller is configured to direct the motion of the at least one robot toward a region defined by a position of at least one tracked human body member.

15. The robotic system of claim 1, wherein the controller is configured to direct the motion of the at least one robot performing the at least one robotic operation based on positions of human body members recorded during one or more prior performances of the at least one human-performed operation.

16. The robotic system of claim 15, wherein the recorded positions are of a current human operator.

17. The robotic system of claim 15, wherein the recorded positions are of a population of previous human operators.

18. The robotic system of claim 1, wherein the controller is configured to direct the motion of the at least one robot performing the at least one robotic operation, based on predicted positions of the body members during the motion, wherein the predicted positions are predicted based on current movements of the body members.

19. The robotic system of claim 18, wherein the predicted positions of the body members are predicted based on at least the current position and velocity of the body members.

20. The robotic system of claim 19, wherein the predicted positions of the body members are further predicted based on the current acceleration of the body members.

21. The robotic system of claim 15, wherein the controller is configured to predict future positions of body members based on matching of current positions of body members in the collaborative workspace to positions tracked during the prior performances.

22. The robotic system of claim 21, wherein the controller predicts future positions based on positions recorded during the prior performances that followed the matching prior performance positions.

23. A method of controlling a robot in a collaborative workspace, wherein the method comprises:
recording positions of individual human body members performing a human-performed operation within the collaborative workspace; and then
planning automatically motion of a robot moving within the collaborative workspace using the prior recordings of positions to define regions of the workspace to avoid or target; and
moving automatically the robot within the collaborative workspace based on the planning, while the human-performed operation is performed.

24. The method of claim 23, wherein the robot is moved to avoid regions near positions of human body members in the prior recordings of positions.

25. The method of claim 24, wherein the avoiding is planned to reduce a risk of dangerous collision with human body members in the positions of human body members in the prior recordings of positions.

26. The method of any one of claims 23-25, wherein the robot is moved to seek regions defined by positions of human body members in the prior recordings of positions.

27. The method of claim 26, wherein the regions defined are defined by an orientation and/or offset relative to the human body members in the prior recordings of positions.

28. The method of claim 26, wherein the seeking is planned to bring the robot into a region where it is directly available for collaboration with the human-performed operation.

29. The method of claim 23, further comprising:
recording, during the moving automatically, positions of human body members currently performing the human-performed operation; and
adjusting the moving automatically, based on the positions of the human body members currently performing the human-performed operation.

30. The method of claim 29, wherein the adjusting is based on the current kinematic properties of the human body members currently performing the human-performed operation.

31. The method of claim 30, wherein the adjusting extrapolates future positions of the human body members currently performing the human-performed operation, using an equation of motion having parameters based on the current kinematic properties.

32. The method of claim 29, wherein the adjusting is based on a matching between current kinematic properties of the human body members, and kinematic properties of human body members previously recorded performing the human-performed operation.

33. A robotic system supporting simultaneous human-performed and robotic operations within a collaborative workspace, the robotic system comprising:
a workbench having a working surface for arrangement of items used in an assembly task, and defining the collaborative workspace thereabove;
a robotic member; and
a mounting rail, securely attached to the workbench, for operable mounting of the robotic member thereto within robotic reach of the collaborative workspace;
wherein the robotic member is provided with a mounting and release mechanism allowing the robot to be mounted to and removed from the mounting rail without disturbing the arrangement of items on the working surface.

34. The robotic system of claim 33, wherein the mounting and release mechanism comprises hand-operable control members.

35. The robotic system of claim 33, wherein the robotic member is collapsible to a folded transportation configuration before release of the mounting mechanism.

36. A robotic member comprising:
a plurality of robotic segments joined by a joint;
a robotic motion controller;
wherein the joint comprises:
two plates held separate from one another by a plurality of elastic members, and
at least one distance sensor configured to sense a distance between the two plates; and
wherein the robotic motion controller is configured to reduce motion of the robotic member, upon receiving an indication of a change in distance between the two plates from the distance sensor.

37. The robotic member of claim 36, wherein the motion controller stops motion of the robotic member upon receiving the indication of the change in distance.

38. The robotic member of any one of claims 36-37, wherein the change in distance comprises tilting of one of the plates relative to the other, due to exertion of force on a load carried by the joint.

39. A method of controlling a robotic system by a human operator, comprising:
determining a current robotic task operation, based on a defined process flow comprising a plurality of ordered operations of the task;
selecting, from a plurality of predefined operation-dependent indication contexts, an indication context defining indications relevant to the current robotic task operation;
receiving an indication from a human operator;
carrying out a robotic action for the current operation, based on a mapping between the indication and the indication context.

40. The method of claim 39, wherein the indication comprises a designation of an item or region indicated by a hand gesture of the human operator, and a spoken command from the human operator designating a robotic action using the designated item or region.

41. The method of any one of claims 39-40, wherein the defined process floe comprises a sequence of operations, and the determining comprises selecting a next operation in the sequence of operations.

42. A method of configuring a collaborative robotic assembly task, comprising:
receiving a bill of materials and list of tools;
receiving a list of assembly steps comprising actions using items from the list of tools and on the bill of materials;
for each of a plurality of human operator types, receiving human operator data describing task-related characteristics of each human operator type;
for each of the human operator types, assigning each assembly step to one or more corresponding operations, each operation defined by one or more actions from among a group consisting of at least one predefined robot-performed action and at least one human-performed action; and
providing, for each of the plurality of human operator types, a task configuration defining a plurality of operations and commands in a programmed format suitable for use by a robotic system to perform the robot-performed actions, and human-readable instructions describing human-performed actions performed in collaboration with the robot-performed actions;
wherein the task configuration is adapted for each human operator type, based on the human operator data.

43. The method of claim 42, comprising validation of the provided task configurations by simulation.

44. The method of claim 42, comprising providing, as part of each task configuration, a description of a physical layout of items from the bill of materials and the list of tools within a collaborative environment for performance of the assembly task.

45. The method of claim 42, comprising designating human operator commands allowing switching among the plurality of operations.

46. The method of any one of claims 42-45, wherein at least one of the plurality of human operator types is distinguished from at least one of the others by operator handedness, disability, size, and/or working speed.

47. The method of claim 42, wherein the plurality of human operator types are distinguished by differences in their previously recorded body member motion data while performing collaborative human-robot assembly operations.

48. A method of optimizing a collaborative robotic assembly task, comprising:
producing a plurality of different task configurations for accomplishing a single common assembly task result, each task configuration describing motion during sequences of collaborative human-robot operations performed in a task cell;
monitoring motion of body members of a human operator and motion of a robot collaborating with the human operator while performing the assembly task according to each of the plurality of different task configurations; and
selecting a task configuration for future assembly tasks, based on the monitoring.

49. The method of claim 48, wherein at least two of the plurality of different task configurations describe different placements of tools and/or parts in the task cell.
